(19) United States
(12) Patent Application Publication
(10) Pub. No.: US 2008/0174281 A1
(43) Pub. Date: Jul. 24, 2008

(54) ELECTRICAL POWER GENERATORS

(76) Inventor: Albert Shau, Palo Alto, CA (US)

Correspondence Address: JENG-JYE SHAU, 991 AMARILLO AVE., PALO ALTO, CA, 94303, US

(21) Appl. No.: 12/055,500

(22) Filed: Mar. 26, 2008

Related U.S. Application Data
(63) Continuation-in-part of application No. 12/042,327, filed on Mar. 4, 2008.
Application No. 12/042,327 is a continuation-in-part of application No. 11/309,530, filed on Aug. 18, 2006.
Application No. 11/309,530 is a continuation-in-part of application No. 11/162,285, filed on Sep. 5, 2005, now Pat. No. 7,148,583.

(51) Int. Cl. H02K 7/18

(52) U.S. Cl. 322/1

(57) ABSTRACT

The present invention provides methods to convert motion into electrical energy. These electrical power generators are made compatible with standard batteries so that they can support operations of existing battery powered portable appliances with no or minimal modifications. Electrical power generators of the present invention are therefore more convenient to use than conventional batteries while reducing the needs to replace or recharge batteries. Environment friendly methods are also introduced for generating electrical power.

This application is a continuation in part application of patent application Ser. No. 12/042,327 filed on Mar. 4, 2008. Ser. No. 12/042,327 is a continuation in part application of patent application Ser. No. 11/309,530 filed on Aug. 18, 2006. Ser. No. 11/309,530 application is a continuation in part application of patent application Ser. No. 11/162,285 filed on Sep. 5, 2005. The Ser. No. 11/162,285 application was granted as U.S. Pat. No. 7,148,583 on Nov. 22, 2006.

### DESCRIPTION

### Background of the Invention

The present invention relates to electrical power generators, and more particularly to electrical power generators that are compatible with battery powered portable appliances.

Current art portable electrical appliances, such as flash lights, remote controllers, pagers, cellular phones and laptop computers, require batteries as their power sources. Compared to electrical appliances that require power cords, these portable appliances are far more convenient to use. However, batteries run out of charge, limiting the time one can use certain appliances. Cameras run out of batteries when pictures need to be taken. Laptops shut down during important presentations. The constant need to replace or to re-charge drained batteries is therefore a source of inconvenience for current art portable electrical appliances.

Many inventions have been developed to address this problem. Campagnuolo et al. disclosed a portable hand-cranked electrical power generator in U.S. Pat. No. 4,227,092, and a leg driven power generator in U.S. Pat. No. 4,746,806. Those power generators were “lightweight” at the time of the inventions, but are far too heavy for today's portable appliances. In U.S. Pat. No. 5,905,359, Jimena disclosed a relatively small electrical power generator installed in a flash light. This power generator used the batteries in the flash light as a flying wheel to store kinetic energy, and used magnetism to convert rotational motion of the flying wheel into electrical energy. Users must purchase special apparatuses installed with rotational batteries and power generators in order to utilize Jimena's invention. In U.S. Pat. No. 6,220,719, Vetrorino disclosed another method to build a renewable energy flashlight. Vetrorino's flashlight used a power generator that is similar to one of the example (FIG. 1) in the present invention. However, the power generator is attached to the flash light in Vetrorino patent so that users must purchase the whole flash light in order to utilize Vetrorino invention; the same power generator is not useful for other appliances. Haney et al. disclosed a manually-powered portable power generator. The apparatus comprises of a manually operable air pump that provides a compressed flow of air used to rotate an electrical power generator. Users must use a specially designed air pump and power generator to use the invention.

These inventions are all valuable methods to provide electrical power. However, none of them have been widely used. The major reason is that they miss the key value of portable appliances. The most important advantage of portable appliances is convenience. If the users need to purchase special apparatuses or wear special gears to charge portable devices, the additional inconvenience defeats the original purpose of portable appliances. Most users would rather use conventional batteries because of availability and convenience. To be popularly used, portable power generators must be made more convenient to use than conventional batteries. In order to achieve those goals, we believe that portable electrical power generators must be compatible with existing battery powered appliances. Such power generators should be as easy to use as conventional batteries, and be more convenient to replace or recharge.

Batteries have other problems. Much more energy is used to manufacture batteries than actually provided by the battery. When batteries are used up and discarded, the chemicals in the batteries pollute the environment. Typical battery usage is therefore a terrible pollution source. There are environment-friendly methods of generating electrical power such as solar cells or wind mills. Van Breems disclosed an apparatus to convert tidal energy into electrical energy in U.S. Pat. No. 6,833,631. However, these environment-friendly methods provide insignificant amounts of energy compared to overall energy consumption. Due to cost considerations, human beings are still burning oil, building dams, building nuclear power plants, and using energy-inefficient batteries, polluting the planet to feed energy-hungry human societies. Although those environment-friendly methods have been available for decades, they will not be fully utilized unless their cost is comparable to polluting methods. It is therefore highly desirable to provide cost efficient, environmentally friendly energy sources.

### SUMMARY OF THE INVENTION

The primary objective of this invention is, therefore, to provide portable electrical power generators that are more convenient to use than conventional batteries. The other primary objective of this invention is to provide cost-efficient and environment-friendly methods of generating electrical power. These and other objectives are achieved by providing electrical power generators that are compatible to conventional batteries and by providing environment-friendly methods of building electrical power generators.

While the novel features of the invention are set forth with particularly in the appended claims, the invention, both as to organization and content, will be better understood and appreciated, along with other objects and features thereof, from the following detailed description taken in conjunction with the drawing.

### BRIEF DESCRIPTION OF THE DRAWINGS

FIGS. 1(a-c) illustrate one example of an electrical power generator of the present invention that is compatible with standard size AA conventional batteries;

FIG. 1(d) is a symbolic circuit diagram showing electrical connections for the electrical power generator shown in FIGS. 1(a-c);

FIG. 2 illustrates one example of an electrical power generator of the present invention that is compatible with standard size D conventional batteries;

FIGS. 3(a-d) are examples of electrical power generators of the present invention that use free moving magnets to convert motion into electrical energy;

FIGS. 4(a-d) are examples of friction cells of the present invention that use friction to convert motion into electrical energy;

FIGS. 5(a-e) demonstrates different methods to make methods of the present invention compatible with existing electrical appliances;

FIG. 6 shows an environment-friendly cost-efficient method to convert tidal energy into electrical energy;

FIGS. 7(a-h) illustrate the operation principles of field effect motion cells of the present invention;

FIGS. 8(a-f) show additional examples for field effect motion cells of the present invention;

FIGS. 9(a-c) are examples for the applications of the present invention to collect wave energy;

FIGS. 10(a-g) illustrate examples of applications of the present invention to throwing toys that spin on an axis parallel to the ground;

FIGS. 11(a-b) illustrate an electrical power generator that uses a loosely hanging part and a rotating part applied to objects that spin on an axis perpendicular to the ground;

FIGS. 12(a-d) illustrate an example of an application of the present invention to measure speed of movement in a computer mouse;

FIGS. 13(a-e) illustrate an example of motion cells applied to buttons;

FIGS. 14(a-n) illustrate an example of an electrical power generator of the present invention that amplifies small movements into big ones;

FIGS. 15(a-l) illustrate another example of an electrical power generator of the present invention that amplifies small movements into big ones; and

FIG. 16 illustrates a circuit that uses a capacitor to build up necessary voltage before charging a battery.

### DETAILED DESCRIPTION OF THE INVENTION

The present invention describes methods to make electrical power generators that convert motion into electrical energy. In addition, these methods make the power generators user friendly by making them compatible with existing battery powered appliances. For simplicity, we will call such “motion-activated battery-compatible electrical power generating device” of the present invention a “motion cell” or “m-cell”. In most of the preferred embodiments, an m-cell of the present invention can replace a conventional battery to allow an existing battery-powered appliance to function normally with no or minimal modifications to the appliance. The word “compatible” in our definition does not always mean identical in every detailed specification. For example, the storage capacity of an m-cell is often less than the storage capacity of a conventional battery of the same size, but the life time of an m-cell is usually much longer than the life time of a conventional battery because of its capability to recharge itself. The output of an m-cell does not always need to be at constant voltage like most conventional batteries. An m-cell is “compatible” with a conventional battery in terms of its user-friendliness in replacing existing batteries while making battery powered appliances function normally, but it is not necessarily always able to replace batteries for all applications. For example, m-cell is especially useful for applications that require small bursts of energy such as remote controllers, flash lights, cellular phones, etc., but m-cell may be only helpful but not replaceable for other applications, especially those that require constant high power operations.

To facilitate clear understanding of the present invention, simplified symbolic views are used in the following figures. Objects are often not drawn to scale in order to show novel features clearly.

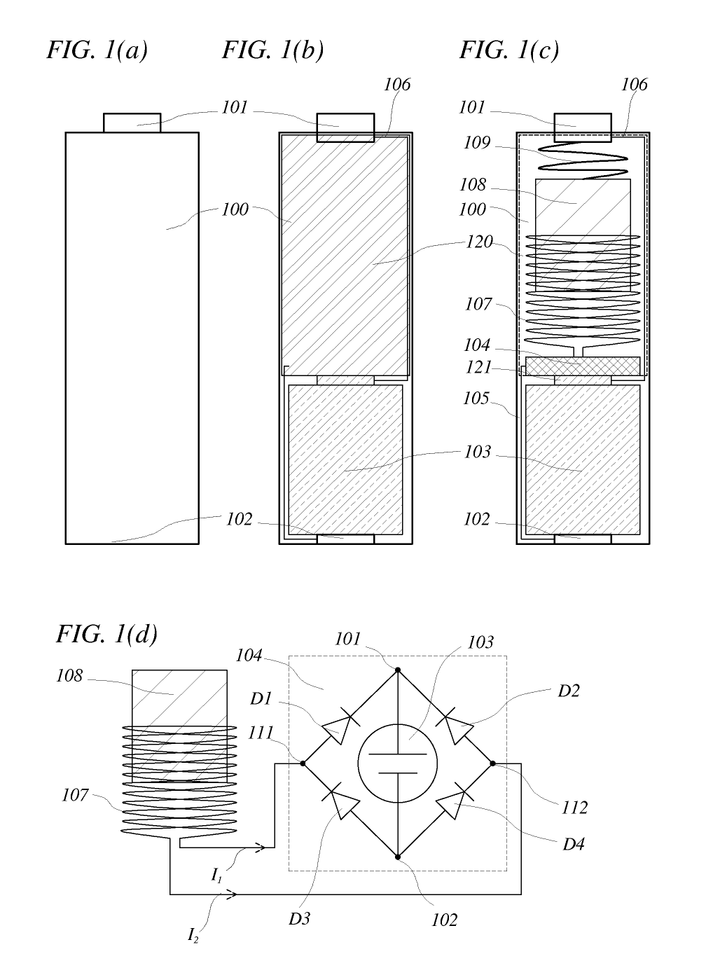

FIG. 1(a) shows the external view of one example of an m-cell (100) of the present invention that is similar in external dimension to a standard AA battery. This m-cell (100) has an anode (101) electrode and a cathode (102) electrode compatible with a standard AA battery. FIG. 1(b) is a cross-section diagram of the m-cell in FIG. 1(a), revealing that the m-cell comprises of a conventional rechargeable battery (103) and an electrical power generator (120). The size of the rechargeable battery (103) is smaller than a conventional AA battery in order to make room for the electrical power generator (120). Any well-known rechargeable battery, such as a Nickel Metal Hydride (Ni-MH) or Nickel Cadmium (NiCd) battery, can be used in this example. FIG. 1(c) is a cross-section diagram revealing one example of the electrical power generator (120) in FIG. 1(b) that comprises of a rectifier circuit (104), an electrical coil (107), and a magnet (108) that is attached to a spring coil (109). FIG. 1(d) is a symbolic circuit diagram illustrating the electrical connections of the components in the m-cell shown in FIG. 1(c). The rectifier circuit (104) is represented by a typical 4-diode (D1-D4) circuit configuration as shown in FIG. 1(d). The anode electrode (121) of the rechargeable battery (103) is connected to the anode electrode (101) of the m-cell (100) through an electrical connection (106), and to the rectifier circuit (104) as shown in FIG. 1(c) and FIG. 1(d). The cathode electrode of the rechargeable battery is connected to the cathode electrode of the m-cell (102), and to the rectifier circuit (104) through an electrical connection (105) as shown in FIG. 1(c) and FIG. 1(d). The electrical coil (107) is connected to the inputs of the rectifier circuit (104) as illustrated in FIG. 1(c) and FIG. 1(d). The magnet (108) is connected to the container of the m-cell through a spring coil (109) as illustrated in FIG. 1(c). In this configuration, external motion of the m-cell can cause the magnet (108) to vibrate up and down through the electrical coil (107). This motion induces changes in magnetic field in the coil that generates alternating electrical currents (I₁, I₂) as illustrated in FIG. 1(d). When the motion generated electrical current is in the direction of I₁, the current will flow through diode D1 and diode D4 to charge the rechargeable battery (103). When the motion generated electrical current is in the direction of I₂, the current will flow through diode D2 and diode D3 to charge the rechargeable battery (103). In other words, the rectifier circuit (104) redirects the generated currents (I₁, I₂) to the right polarity in order to charge the battery (103). This m-cell is fully compatible with conventional AA batteries while it is able to recharge itself by converting motion into electrical energy.

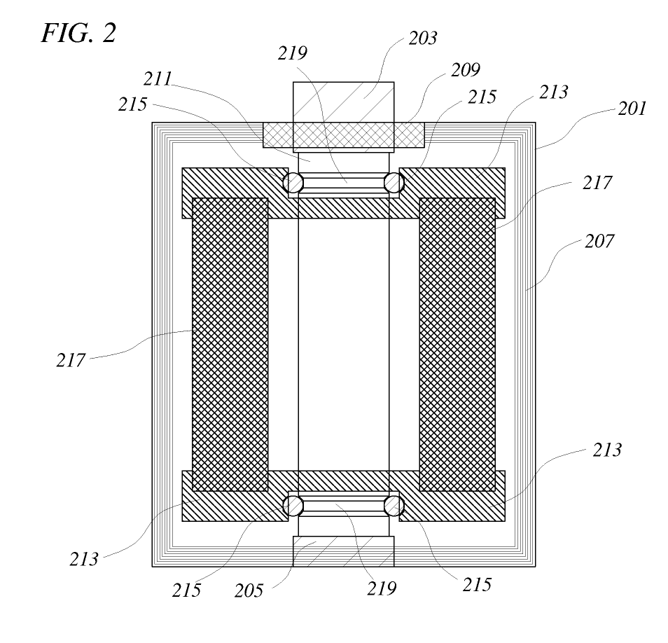

While specific embodiments of the invention have been illustrated and described herein, other modifications and changes will occur to those skilled in the art. For example, the shape of an m-cell does not have to meet the shape of a particular type of battery such as an AA battery; it can meet the shape of many kinds of existing batteries. The container of an m-cell also does not have to fit the space for one battery; it can fit into the space for two or more batteries, or the space for a fraction of a battery. In the above example, a typical 4-diode rectifier is used as one example of the rectifier circuit supporting an m-cell of the present invention. There are many other methods to implement rectifier circuits, ranging from mechanically controlled switches to highly sophisticated integrated circuits. Rectifiers are well known to those familiar with the art so there is no need to provide further details in our discussions. We also do not always need all the components shown in the above example. For certain applications such as a flash light, there is no need to use a rectifier in the m-cell. An m-cell also does not always need to work with an internal rechargeable battery. For example, we can replace the rechargeable battery with other types of storage devices such as capacitors. For many applications, we may not even need any storage devices in the m-cell. There are also many ways to implement electrical power generators for m-cells. In the above example, the vibrating motion of a magnet is converted into electrical energy. We can modify the configuration to allow an electrical coil to vibrate around a fixed magnet to achieve the same purpose. There are many other ways to build the power generator. A common way is to use a rotating magnet instead of vibrating magnet as illustrated by the example in FIG. 2.

FIG. 2 illustrates an example of an m-cell (201) that is compatible with size D batteries. A rechargeable battery is placed within the center axis (211) of the container. The anode electrode of the rechargeable battery is connected to the anode electrode (203) of the m-cell and a rectifier circuit (209). The cathode electrode of the rechargeable battery is connected to the cathode electrode (205) of the m-cell and the rectifier circuit (209). The rectifier circuit (209) is also connected to electrical coils (207) surrounding the walls of the m-cell container. Two magnets (217) are placed on rotational frames (213). Rolling balls (215) moving within rotational channels (219) on the center axis (211) allow the rotational frames (213) to rotate around the center axis (211) with small friction. It is desirable to use two magnets (217) of different weight so that external motion of the m-cell will cause the magnets (217) to rotate around the center axis (211). The change in magnetic field induced by the rotational motions generates electrical currents that are redirected by the rectifier circuit (209) to charge the rechargeable battery based on similar principles as those used in the m-cell in FIGS. 1(a-d). This m-cell is therefore fully compatible with conventional size D batteries while it is also able to recharge itself by converting motion into electrical energy.

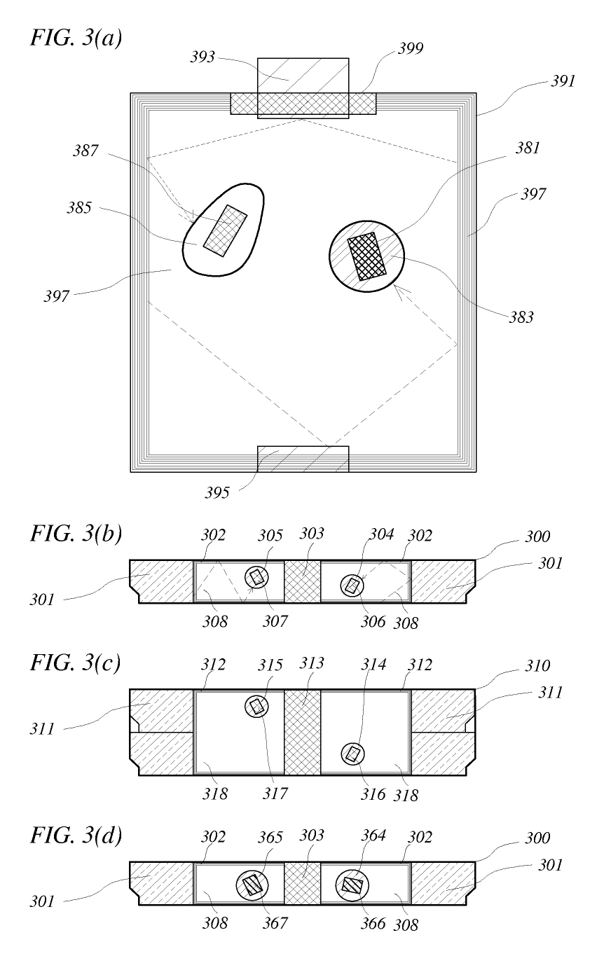

For the examples in FIGS. 1-2, external motion of an m-cell is converted into one dimensional motion (back and forth motion in FIG. 1 and rotation along one axis in FIG. 2) of magnets relative to electrical coils in order to convert motion into electrical energy. FIG. 3(a) shows an example of an electrical power generator of the present invention that is able to convert multiple dimensional motions into electrical energy. Similar to the example in FIG. 2, the m-cell (391) in FIG. 3(a) has a container, an anode electrode (393), and a cathode electrode (395) making it compatible with conventional batteries. A rechargeable battery may be placed inside but it is not shown for simplicity. Similar to the m-cell in FIG. 2, this m-cell (391) is also surrounded by electrical coils (397) that are connected to a rectifier circuit (399). These configurations allow the m-cell (391) to generate electrical energy as soon as there is a changing magnetic field within the electrical coils (397). In this example, the changing magnetic field is provided by a free moving magnet (381) in a bouncing ball (383). There are many ways to build this bouncing ball (383); one example is to coat a magnet (381) with elastic materials like rubber. External motion of the m-cell (391) can cause the bouncing ball (383) to bounce around and to rotate within the electrical coils (397) causing changes in magnetic fields that generate electrical currents. The three dimensional motions plus rotational motions of the bouncing ball (383) all can generate electrical energy. The bouncing ball also does not have to be a sphere. An irregular shape is actually preferable because it can cause rapidly changing magnetic fields. FIG. 3(a) also shows another example of a free-moving object (385) that has a magnet (387) coated by irregularly shaped elastic materials. Although two bouncing objects (383, 385) are shown in FIG. 3(a) for convenience in drawing, it is usually undesirable to have two such bouncing objects within one container because they will tend to cancel the power generating effects of each other.

Manufacture procedures for the bouncing magnets (383, 385) can be extremely simple and inexpensive. Such simplicity in manufacture provides the flexibility to make free-moving magnets in very small sizes, allowing the possibility to build small size m-cells. FIG. 3(b) shows an example of an m-cell (300) of the present invention that is made compatible with a typical button cell or coin cell battery. Coin cells are typically used in car keys with a thickness of around one millimeter (mm) and a diameter of around 15 mm. Button cells are typically used in electrical watches and cameras with a thickness of around 5 mm and a diameter of less than 10 mm. It is nearly impossible to put prior art electrical power generators into such small dimensions. The m-cell shown in FIG. 3(b) is compatible in size with a typical coil cell. The inner space of the m-cell comprises of one or more chambers (308). Each chamber (308) comprises of electrical coils (302) and space for small free-moving magnet(s) (304, 305) of the present invention. It is typically desirable to place a rechargeable battery (301) and rectifier circuit (303) in the m-cell as illustrated in FIG. 3(b). External motions of the m-cell (300) can cause the bouncing magnets (304, 305) to bounce around and to rotate relative to the electrical coils (302) in the chambers (308). The magnets (306, 307) in the free-moving objects (304, 305) create changes in magnetic field to charge the rechargeable battery (301) through the rectifier circuit (303) in similar ways as in previous examples.

Although the m-cell of the present invention can function in a very small space, it is still desirable to have more space for simpler manufacture procedures. FIG. 3(c) shows an example of an m-cell (310) that is made compatible to fit into the space of two stacked coin cells. In this way, one can double the volume of the bouncing chambers (318) and have space for more electrical coils (312). The magnets (316, 317) in the bouncing balls (314, 315) can have more space than in the previous example. This m-cell (310) also can have rechargeable batteries (311) and rectifier circuits (313) similar to previous examples. Most car keys use two stacked coin cells instead of one coin cell. We can replace two stacked coin cells with one m-cell shown in FIG. 3(c) or two m-cells shown in FIG. 3(b).

The m-cells of the present invention are extremely user friendly. For example, we can use m-cells to replace the batteries in a television remote controller without making any changes to the TV remote controller. Whenever the m-cell is running low in charge, a few shakes of the remote controller will charge it enough to support further operations. We also can use m-cells to replace the batteries in a garage door remote controller. When a garage door controller is placed in a car, the natural vibrations and accelerations of the car can keep the m-cells charged. The garage door remote controller will not run out of batteries any more. When a properly designed m-cell is used in a cellular phone, the natural motion of the user is usually enough to keep the m-cell charged—significantly reducing the inconvenience of recharging cellular phone batteries. The present invention certainly can support most battery powered toys.

While specific embodiments of the invention have been illustrated and described herein, it is realized that other modifications and changes will occur to those skilled in the art. The scope of the present invention should not be limited by above specific examples. For example, there are many ways to implement electrical coils for generating electrical power from changing magnetic fields. Detailed designs of those electrical coils are therefore not shown in the above discussions. The m-cells of the present invention can be compatible with all kinds of conventional batteries including, but not limited to, sizes AAA, AA, A, B, C, D, coin cells, button cells, rectangle cells, cellular phone cells, laptop computer batteries, etc. In our examples, the bouncing magnets are coated with elastic materials in order to preserve kinetic energy. In many cases, there is no need to coat the magnets with elastic materials. Free-moving magnets of any shape are applicable. The motions of magnets do not have to be bouncing; other kinds of free motions such as rolling or tumbling also work well. For example, the m-cell shown in FIG. 3(d) is nearly identical to the m-cell shown in FIG. 3(b) except that the bouncing balls (304, 305) are replaced with rolling cylinders (364, 365) that comprise of magnets (366, 367). The rolling motion of the cylinders (364, 365) can cause the magnets (366, 367) to change magnetic fields to generate electric energy.

A free-moving magnet used in the present invention is defined as a magnet that does not have bondage such as rotation frames or spring coils to constrain its motion to one-dimensional motion. Conventional magnetic power generators always confine the motion of magnets relative to electrical coil using rotational frames or vibration spring coils. The magnets or coils are always bounded for linear motion or rotational motion. Such constraints limit the freedom to convert different types of motion into electrical power. The need to provide moving parts such as rotational frames or vibrating frames also makes it more complicated to manufacture. The free moving magnets in the above examples are allowed to move freely in a given container without bondage from frames or springs. The manufacture procedures for such free moving magnetic are simplified, and more freedom in converting different types of motion into electrical energy is attained. Due to simplicity, the free-moving magnet cells are extremely easy to manufacture compared to other types of magnetic power generators. The major disadvantage is its irregular power output due to irregular changes in magnetic fields. The rectifier circuits supporting free-moving magnet cells may need to be more complex than conventional rectifier circuits. Fortunately, current art integrated circuit technologies allow design of highly sophisticated rectifying circuits that can be optimized for such applications. Another method to regulate the output of the free-moving magnet cells is to simplify the motions of the magnets; one example is to allow only rolling motions along one direction.

While specific embodiments of the invention have been illustrated and described herein, it is realized that other modifications and changes will occur to those skilled in the art. The scope of the present invention should not be limited by above specific examples. For the above examples, magnetic mechanisms are utilized as the electrical power generating mechanism. Other mechanisms are also applicable for m-cells of the present invention.

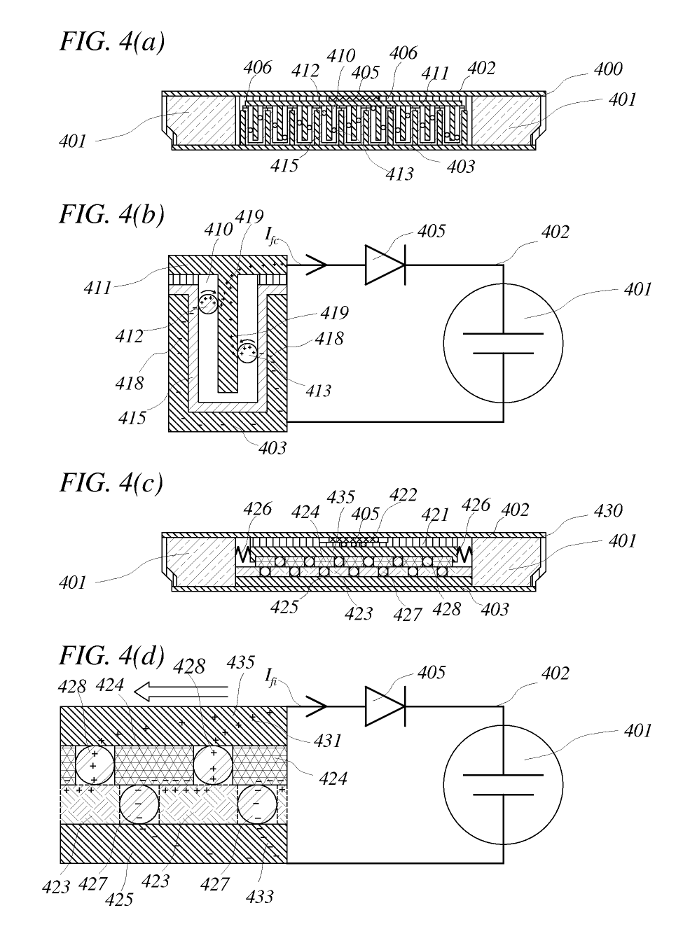

FIG. 4(a) shows an example of an m-cell (400) of the present invention that is similar in external shape to the example shown in FIG. 3(b). It also can have rechargeable batteries (401) that can be placed in similar ways. The anode electrode of the rechargeable battery is connected to the anode electrode (402) of the m-cell (400). The cathode electrode of the rechargeable battery is connected to the cathode electrode (403) of the m-cell (400). There are a plurality of “friction cells” (410) packed inside the m-cell (400). A magnified cross section view for one of the friction cells (410) is shown in FIG. 4(b). FIG. 4(b) also shows symbolic circuit connections of the m-cell in FIG. 4(a). A friction cell of the present invention generates electric energy from friction between different materials. For this example, the friction cell comprises of a cathode electrode that is also connected to the cathode electrode (403) of the m-cell (400). The cathode electrode of the friction cell is covered by a layer of friction coating (415) as illustrated in FIG. 4(a) and FIG. 4(b). The anode electrode (411) of the friction cell is connected to a rectifier circuit (405) as shown in FIG. 4(a). The rectifier circuit (405) is represented by a single diode in FIG. 4(b) but there are many methods to implement this rectifier circuit. Inside the friction cell (400), there are rolling cylinders (412, 413) that roll between the friction cell anode electrode (411) and the friction coating (415) on the cathode electrode (403). For this example, we assume that the friction coating (415) is made of materials that have high electron affinity such as conductive plastic materials, and the rolling cylinders (412, 413) are made of conductive materials that have low electron affinity such as heavy metal. The friction generated by the rolling motion of those rolling cylinders (412, 413) can cause the rolling cylinders (412, 413) to carry positive charges (419) that are represented by (+) signs in FIG. 4(b). In the mean time, the friction will generate negative charges (418) on the friction coating (415). The negative charges (418) are represented by (−) signs in FIG. 4(b). Due to voltage differences, the positive charges (419) will flow to the anode electrode (411) of the friction cell (410), and the negative charges (418) generated by friction will flow to the cathode electrode (403). The charge flows creates an electrical current (I_{fc}) that can charge the rechargeable battery (401). In such ways, the external motions of the m-cell (400) can cause friction between the rolling cylinders (412, 413) in the friction cells (410) to generate electrical energy.

While specific embodiments of the invention have been illustrated and described herein, it is realized that other modifications and changes will occur to those skilled in the art. The scope of the present invention should not be limited by above specific examples. Friction cells of the present invention can be implemented in many ways. FIG. 4(c) shows another example that has a similar structure to that in FIG. 4(a) except that its friction cell comprises of two friction planes (425, 435). The bottom friction plane (425) is a fixed conductive plate connected to the cathode electrode (403) of the m-cell (430). There are friction coating (423) materials attached to this bottom friction plane (425), and conductor rolling cylinders (427) placed between the friction coating (423) as illustrated by the magnified cross section drawing in FIG. 4(d). FIG. 4(d) also shows the symbolic circuit connections for the m-cell (430) in FIG. 4(c). The top friction plane (435) is a movable conductor plate attached to spring coils (426) as illustrated in FIG. 4(c). There are friction coating (424) materials attached to this top friction plane (435), and conductor rolling cylinders (428) placed between the friction coating (424) as illustrated by FIG. 4(d). This top friction plane (435) is also the anode electrode of the friction cell that is connected to a rectifier circuit (405) through conductor rolling cylinders (422) as illustrated in FIG. 4(c). External motion of the m-cell (430) can cause the top friction plane (435) to vibrate relative to the bottom friction plane (425). The two kinds of friction coating (423, 424) attached to the two friction planes (425, 435) generate electrical charges (431, 433) while rubbing against each other. In this example, we assume the bottom friction coating (423) generates positive charges (431) while the top friction coating (424) generates negative charges (433). When the bottom friction coating (423) touches the top rolling cylinders (428), positive charges (431) will flow toward the anode plane (435). When the top friction coating (424) touches the bottom rolling cylinders (427), negative charges (433) will flow toward the cathode plane (425). The charge flow generates an electrical current (I_{fi}) that can charge the rechargeable battery (401). In such ways, the external motions of the m-cell (430) can generate electrical energy.

Friction was the earliest method to generate electricity in the earliest days of scientific studies of electricity, but magnetism became the dominating mechanism for electrical power generators. There is lot of room for improvement to find better materials and to have better designs in friction cells of the present invention. Unlike magnetic power generators, friction cells do not require heavy materials such as magnets and electrical coils so that they have more flexibility in supporting applications of the present invention. Friction cells can be built from low cost materials or even bio-degradable materials. There is better flexibility to arrange friction cells into different shapes. Upon disclosure of the present invention, a wide variety of friction cells are expected to be developed.

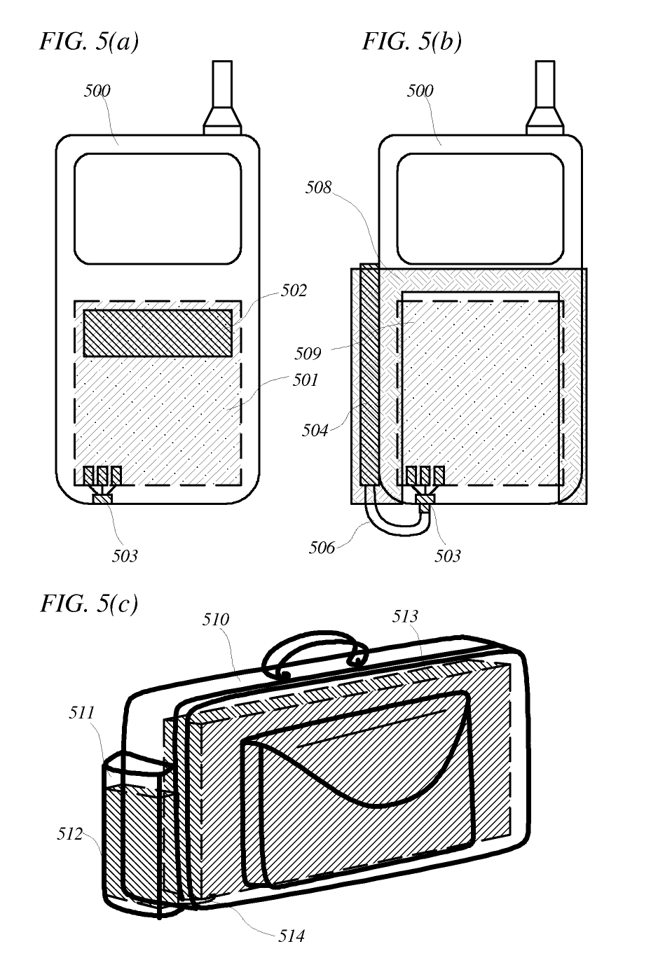

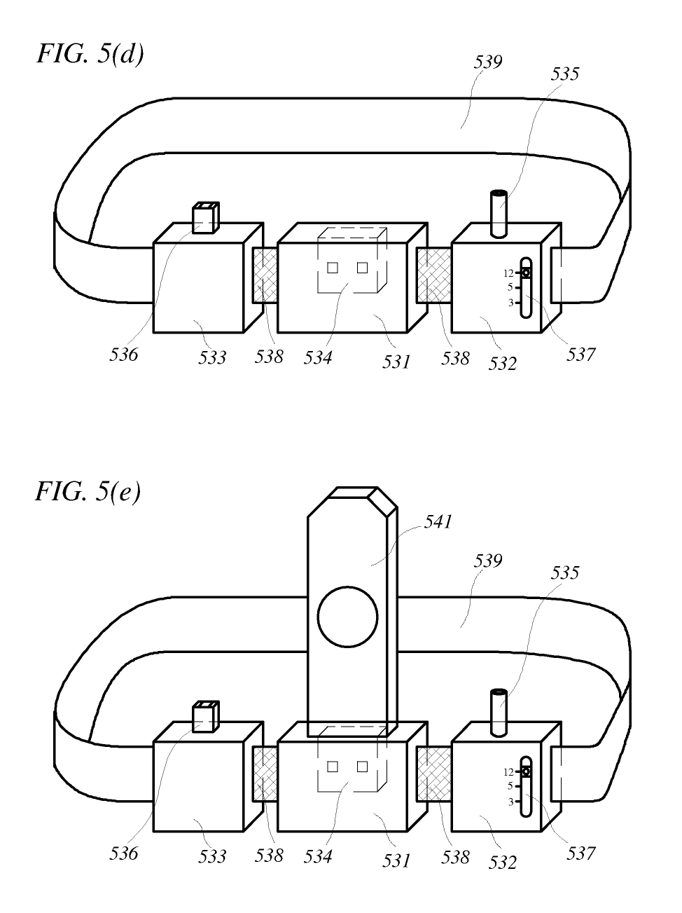

While specific embodiments of the invention have been illustrated and described herein, it is realized that other modifications and changes will occur to those skilled in the art. The scope of the present invention should not be limited by above specific examples. In the above examples, electrical power generators are placed in battery-shaped containers to make them compatible with existing batteries. That is not the only way to make electrical power generators compatible with existing battery-powered appliances. FIG. 5(a) shows a symbolic view for one example when a cellular phone (500) is equipped with a rechargeable battery (501). We can place an m-cell (502) of the present invention to occupy part of the space inside the battery (501) as a method to make m-cell compatible with a cellular phone (500). However, that is not the only method. Cellular phones are often placed in a protective coat (508). The battery (501, 509) used by cellular phones always has input socket (503) for chargers. We can place an m-cell (504) of the present invention attached to the protection coat as illustrated in FIG. 5(b), and connect the power output of the m-cell to the cellular phone battery (509) through existing input socket (503). In this way, we do not need to make any changes to existing cellular phones (500) and do not need to make any changes to existing cellular phone batteries (509), while we enjoy the convenience provided by m-cells (504) by attaching the m-cell to the cellular phone protection coat (508). Similar designs are applicable to other types of portable devices such as video recorders, digital cameras, black berry, audio recorders, radios, audio headsets, microphones, or laptop computers. For example, an m-cell (512) can be placed inside a side pocket (511) of a typical bag (510) used to carry a lap-top computer (513) as illustrated in FIG. 5(c). The power output of the m-cell (514) is plugged into the charger input of the laptop computer while the user carries the computer in the bag. When the bag (510) is carried or when it is placed in a vehicle, the natural motions of the bag (510) are constantly converted into electrical energy by m-cell (512) to keep the battery charged to help reduce the needs to recharge the battery. In the mean time, there is no need to make any changes to the laptop computer as well as its battery. The same bag also can be used to carry and to charge other types of portable appliances such as video recorders.

FIG. 5(d) shows a device comprising a plurality of m-cells (531-533) attached to a flexible belt (539). The flexible belt (539) allows this device to be attached to user's wrist, ankle, forehead, or other body parts. The attached m-cells (531-533) convert motion into electrical energy. The m-cells may have storage devices (not shown) to store generated electrical energy. The outputs (534-536) of these m-cells (531-533) are designed to be compatible with existing portable devices. For example, the power output of one m-cell (531) is shaped to accept Universal Serial Bus (USB) interface (534). Portable devices charged through USB interface, such as iPOD or MP3 music players, can be charged using this interface (534). The power output (535) of the second m-cell (532) is shaped to accept portable computers or cellular phones. In this example, the m-cell (532) is equipped with a switch (537) used to select the voltage of power output. The power output (536) of another m-cell (533) is shaped to accept digital cameras. These m-cells (531-533) can be connected electrically using flexible connections (538) to share generated power. It is desirable to have the flexibility to attach or detach m-cells to the same belt (539). Not every m-cell has to have its own power output; we can have m-cells that are used only to generate electrical power. FIG. 5(e) illustrates the situation when an iPOD (541) is charged by the device in FIG. 5(d). Similar designs are applicable to other types of portable devices such as video recorders, digital cameras, black berry, audio recorders, radios, audio headsets, microphones, or laptop computers.

While specific embodiments of the invention have been illustrated and described herein, it is realized that other modifications and changes will occur to those skilled in the art. The scope of the present invention should not be limited by above specific examples. The key features for the examples shown in FIGS. 5(a-e) are detachable power outputs of m-cells that are compatible with the battery charger inputs of existing portable devices. Such compatible power outputs allow m-cells to provide electrical energy to existing portable appliances with no or minimal modifications to the portable appliances. The detachable power outputs also allow the users to use the same m-cells to support different appliances. These key features allow m-cells of the present invention to be extremely convenient to users.

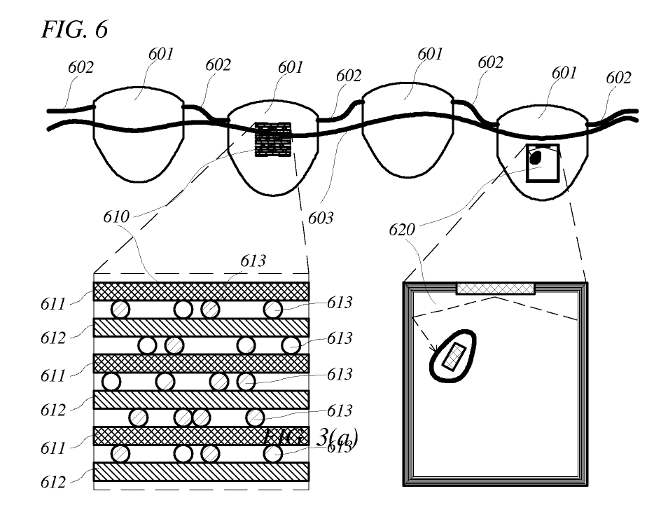

Besides providing additional conveniences for battery powered appliances, another primary objective of the present invention is to make energy generators more environment-friendly. By reducing the need to replace batteries, the present invention already can help reduce pollution. In addition, all the components for m-cells of the present invention can be manufactured without dangerous chemicals. The friction cells actually can be manufactured with bio-degradable natural materials at very low cost. Therefore, the present invention can provide environment-friendly methods to generate electrical power. FIG. 6 is a symbolic diagram showing a plurality of m-cells placed into buoys (601) that are placed on water (603) and linked by cables (602). The cables (602) contain electrical wires to transfer generated electrical energy to energy storage devices. The buoys (601) can be decorated as natural objects such as coconuts to make their look also environment-friendly. Any one of the m-cells of the present invention can be used for such applications. For example, we can use a friction cell (610) as shown by the magnified cross section diagram in FIG. 6. In this example, the friction cell (610) comprises of rolling balls (613) rolling between cathode plates and anode plates (611, 612). The water waves will cause those rolling balls to move around causing friction to separate positive and negative charges. Those separated charges are collected by the conductive cathode plates and anode plates to generate electrical power. FIG. 6 shows another example that uses a bouncing magnet cell (620) similar to the one in FIG. (2). Such power generators of the present invention are simple in structure so that electrical energy can be collected at very low cost. Those cells can be built completely from environment-friendly materials so that they won't cause any environment problems even when they are destroyed by accidents. We prefer not to place rechargeable batteries in the buoys to avoid chemical materials for environment considerations, but it is also possible to place rechargeable batteries in the buoys for easiness in collection of produced energy. An energy storage device can be placed on shore to store the energy generated by those m-cells. In such method, tidal energy can be converted into electrical power using cost efficient and environment-friendly methods. M-cells of the present invention also can be placed in vehicles such as boats or cars, and the natural motion of the vehicles will create clean, cost efficient energy.

While specific embodiments of the invention have been illustrated and described herein, it is realized that other modifications and changes will occur to those skilled in the art. The scope of the present invention should not be limited by above specific examples. For example, instead of using magnetic components to generate electrical power, we can use field effect motion cells of the present invention to convert motion into electrical energy.

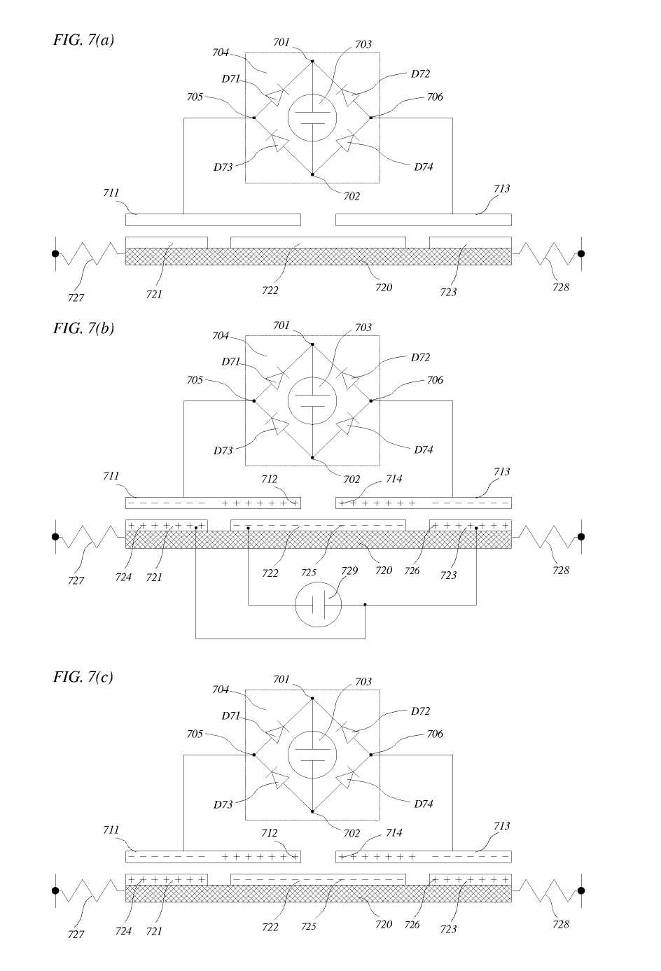

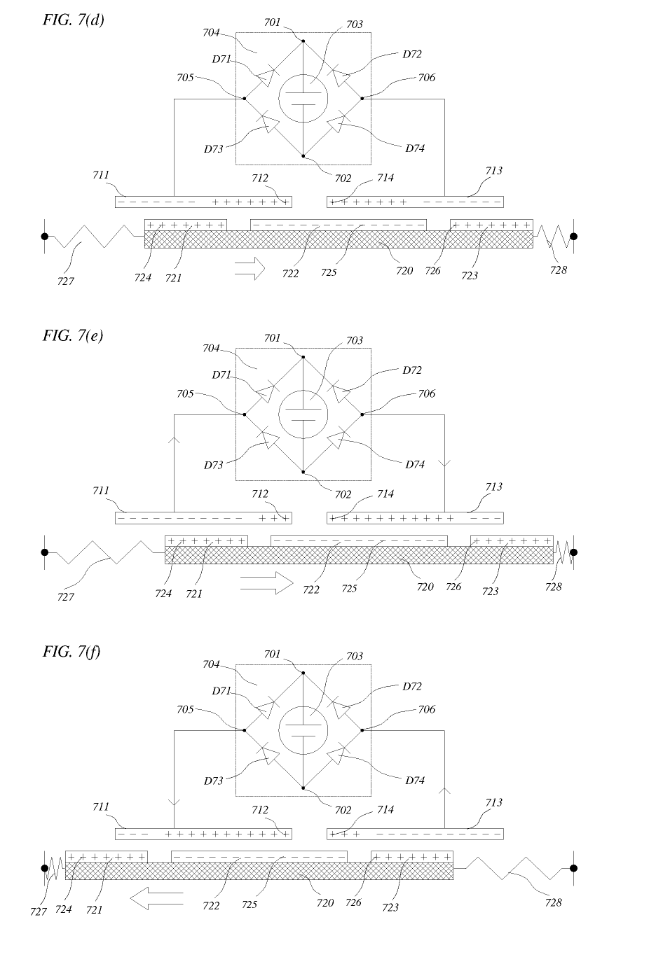

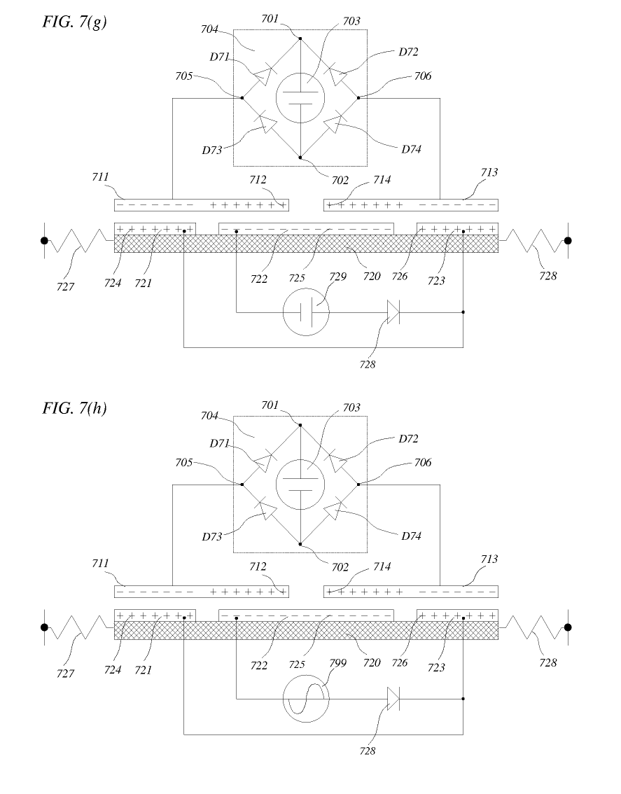

FIG. 7(a) is a simplified symbolic diagram illustrating the basic structures for one example of a field effect motion cell of the present invention. In this example, a rechargeable battery (703) is connected to two output terminals (701, 702) of a rectifier (704) that comprises 4 diodes (D71-D74). The input terminals (705, 706) of the rectifier (704) are connected to two plates (711, 713) called “collector terminals”. These collector terminals (711, 713) are placed closely to three plates (721, 722, 723) called “field terminals”. These field terminals (721, 722, 723) are mounted on a movable carrier (720) that is held between two springs (727, 728) as illustrated in FIG. 7(a). To generate electrical fields, we need to introduce electrical charges to the field terminals (721, 722, 723). There are many ways to charge the field terminals. For example, we can implant electrical charges into insulators or electrically isolated materials and use the charged materials as field terminals. The other way is to apply voltages to the isolated terminals. For example, we can connect the negative electrode of a battery (729) to the center field terminal (722), while connect the positive terminal of the battery to the other two field terminals (721, 723) as illustrated in FIG. 7(b). Typically, the voltage used to charge the field terminals is much higher than the voltage of the rechargeable battery (703). Under the configuration in FIG. 7(b), the electrical field introduced by the applied voltage will introduce negative charges (725) in the center plate (722), positive charges (724, 726) on the other two plates (721, 723), and charges (712, 714) of opposite signs would be induced on the collector terminals (711, 713) as shown in FIG. 7(b). To operate the motion cell, we can keep the charging voltage source (729) connected as shown in FIG. 7(b), we also can disconnect the charging circuit as shown in FIG. 7(c). As shown in FIG. 7(c), the field terminals (721, 722, 723) are electrically isolated so the charges (724, 725, 726) on the field terminals are trapped even if we remove the battery (729). The electrical fields generated by those trapped charges hold the charges (712, 714) on the collector terminals (711, 713) at steady state as illustrated in FIG. 7(c). At steady state, the electrical force between electrical charges will try to hold the movable carrier (720) at the same location. If a force moves the movable carrier away from the steady state location as illustrated in FIG. 7(d), the repelling force between the electrical charges will establish a voltage called the “field induced voltage” across the collector terminals. If the field induced voltage is lower than the voltage of the rechargeable battery (Vr) plus two diode voltage (Vdi), all the diodes (D71-D74) will remain off, no current (except small leakage current) is allowed to flow through the rectifier (704), and the repelling electrical force would try to push the movable carrier (720) back to steady state location. If the motion of the movable carrier is large enough so that the field induced voltage is high enough to turn on the rectifier and allow a current flow from the collector terminal (711) on the left side through D71, rechargeable battery (703), D74, to the other collector terminal (713); the electrical charges on the collector terminals (711, 713) would be redistributed as illustrated in FIG. 7(e), and a new steady state would be established; the motion energy is converted into electrical energy stored in the rechargeable battery (703). Similarly, if a large enough force is applied on the movable carrier (720) to the other direction so that field induced voltage is high enough to generate a current flow from the collector terminal (713) on the right side through D72, rechargeable battery (703), D73, to the other collector terminal (711), the electrical charges on the collector terminals (711, 713) would be redistributed as illustrated in FIG. 7(f); a new steady state would be established, and the motion energy is converted into electrical energy stored in the rechargeable battery (703).

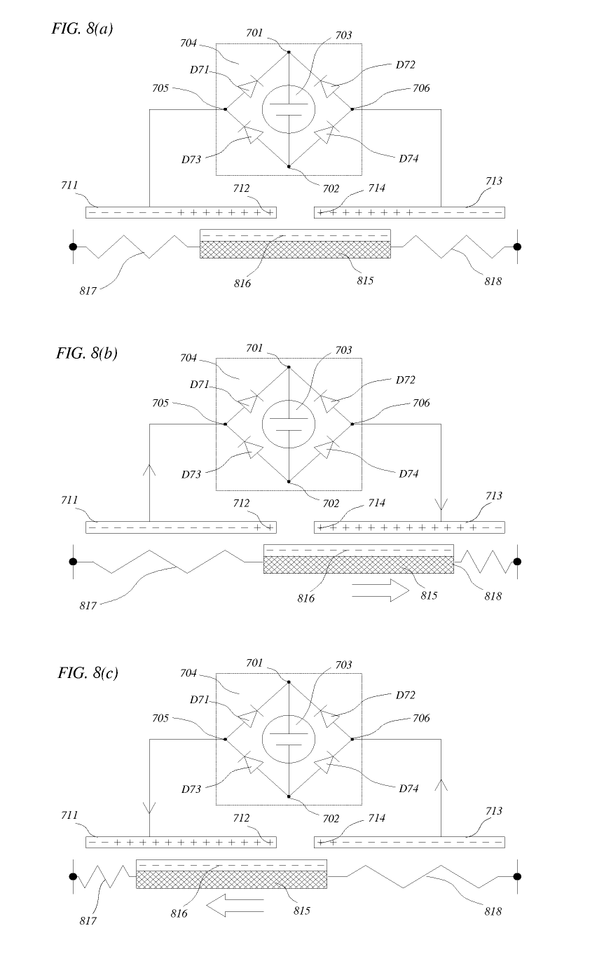

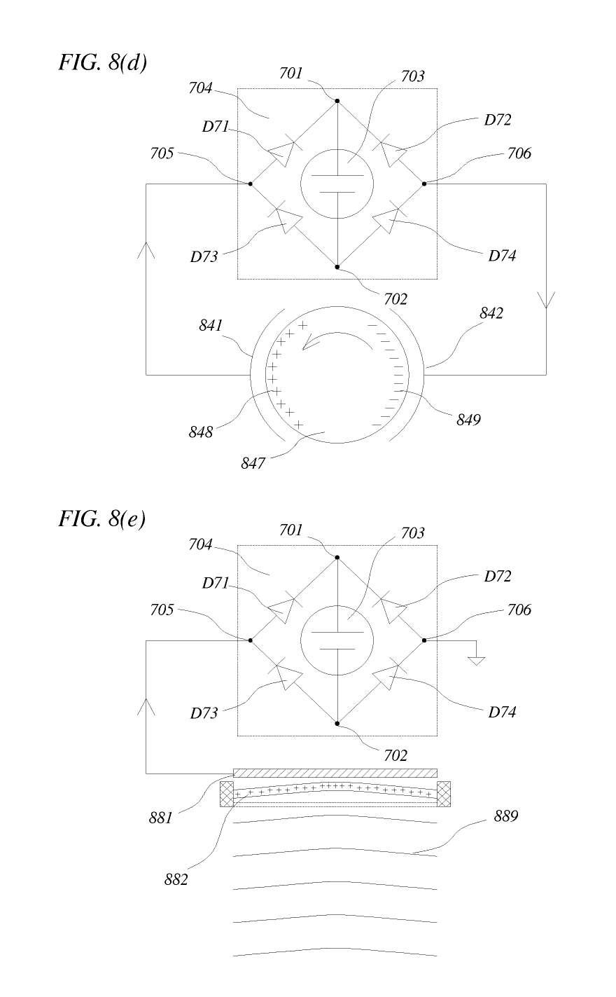

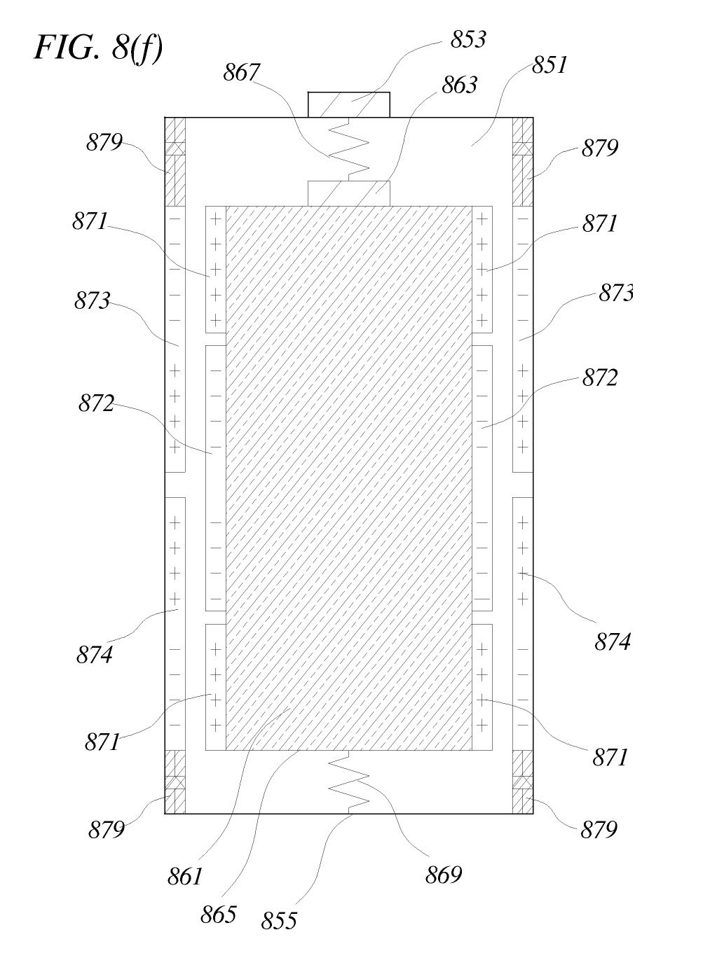

While specific embodiments of the invention have been illustrated and described herein, it is realized that other modifications and changes will occur to those skilled in the art. The scope of the present invention should not be limited by the above specific examples. For example, a typical 4-diode rectifier is used in the above example shown in FIGS. 7(a-f) while wide varieties of circuits are applicable to serve our purpose. The energy storage device in the above example is a rechargeable battery while we can use other types of energy storage device such as a capacitor, flying wheels, or heated water. In our figures, distributions of electrical charges are illustrated by simplified drawings while the actual detailed distributions are more complex. The movable carrier is held by springs (727, 728) which are helpful in storing part of the motion energies, but we certainly do not have to use springs. The key feature for field effect motion cells of the present invention is the mechanism that generates electrical power using the relative motion between field terminal(s) and collector terminal(s). A “field terminal” defined in the present invention is a structure that holds electrical charges to generate electrical fields. Field terminals can be manufactured by many kinds of materials (conductors, semiconductors, or insulators) in different shapes while distributed in different configurations. A “collector terminal” defined in the present invention is a structure that reacts to the electrical fields of the field terminal(s) to generate electrical power from the relative motion between collector terminal(s) and field terminal(s). In the above example the field terminals are placed on a movable carrier while it is equally applicable to place collector terminals on movable carrier(s). The above example has two collector terminals while we can have more collector terminals connected serially or in parallel. The collector terminals do not have to be plates, they can be shaped in many ways. There are many ways to charge the field terminals. In the above example shown in FIGS. 7(a-f) the field terminals are charged by applying a voltage on conductor plates then remove the voltage source. It is well known that materials with build-in charge can be manufactured by implanting charges into insulators or electrically isolated materials. Other methods, such as charging with high voltage then removing the voltage source, also exist. It should be obvious that we do not have to remove the voltage source shown in FIG. 7(b); as soon as the voltage of the charging battery (729) is higher than (Vr+2Vdi), electrical current would only flow into the rechargeable battery (703), instead of the charging battery (729). We certainly can add one diode (728) as shown in FIG. 7(g) to make sure we do not have reversed charge flow on the field terminals. The charging power source also does not have to be a battery, an AC power source (799) and a diode (728) as shown in FIG. 7(h) will work fine. A person with ordinary skill in the art certainly can develop wide varieties of designs for field effect motion cells of the present invention. FIGS. 8(a-e) show more examples.

FIG. 8(a) shows another example of a field effect motion cell of the present invention. The collector terminals, rechargeable battery, and rectifier used in this example are identical to the example shown in FIGS. 7(a-h), while the field terminal in FIG. 8(a) comprises only one terminal (816) charged with one type of charge. This field terminal is placed on a movable carrier (815) between two springs (817, 818). When the movable carrier (815) is pushed far enough to the right hand side, as shown in FIG. 8(b), an electrical current flow from the collector terminal (711) on the left side through D71, rechargeable battery (703), D74, to the other collector terminal (713); the electrical charges on the collector terminals (711, 713) would be redistributed as illustrated in FIG. 8(b), and a new steady state would be established; the motion energy is converted into electrical energy stored in the rechargeable battery (703). When the movable carrier (815) is pushed to the left hand side, as shown in FIG. 8(c), an electrical current flow from the collector terminal (713) on the right side through D72, rechargeable battery (703), D73, to the other collector terminal (711); the electrical charges on the collector terminals (711, 713) would be redistributed as illustrated in FIG. 8(c), and a new steady state would be established; the motion energy is converted into electrical energy stored in the rechargeable battery (703). The example shown in FIGS. 8(a-c) is less efficient than the example shown in FIGS. 7(a-f) while the motion cell is easier to build.

FIG. 8(d) shows an example when the field terminal (847) is a cylinder charged with isolated electrical charges (848, 849). When this field terminal (847) is rotated relative to collector terminals (841, 842), the rotational motion generates electrical power in similar principles.

FIG. 8(e) shows an example that has only one collector terminal (705). The other input of the rectifier (706) is connected to ground voltage. In this example a charged vibration plate (882) is used as a field terminal. This vibration plate (882) deforms when there is change in surface pressure, which may be caused by incoming sound waves (889) or changes in air or fluid pressures. When this field terminal (882) is deformed to be closer or farther from the collector terminal (881), electrical field induced current can go through the rectifier (704) to charge the rechargeable battery (703). The structures of this field effect motion cell in FIG. 8(e) are similar to the structures of microphones. Microphones convert sound energy into electrical signals as sensors to determine the amplitude of sound waves. The present invention provides electrical generators to collect motion energies to provide electrical energy sources. Although motion cells of the present invention also can be used to collect sound energy, the purposes and functions are completely different. Devices based on the principles shown in FIG. 8(e) also can be designed to be effective sound energy absorbers. We can place them along a highway to reduce noise while collecting useful energy.

The field effect motion cells of the present invention have many advantages over magnetic motion cells. Field effect motion cells provide more flexibility to build motion cells in terms of choice in materials, shapes, and structures. It is much easier to shield electrical fields than magnetic fields from influencing other circuits. Field effect motion cells are also typically lighter than magnetic motion cells.

One major objective of the present invention is to provide convenient electrical power generators by fitting the power generator into containers that are compatible with existing batteries. FIG. 8(f) shows an example when a field effect motion cell (851) is shaped to be compatible with existing batteries. A rechargeable battery (861) serves the functions of energy storage device as well as the field terminal carrier. The positive electrode (863) of the rechargeable battery is connected to the positive electrode (853) of the motion cell through a metal spring (867). The negative electrode (865) of the rechargeable battery is connected to the negative electrode (855) of the motion cell through another metal spring (869). These springs (867, 869) are electrical conductors and provide mechanical support. They also act as energy storage devices to store part of the motion energy. Charged field terminals (871, 872), are placed on the surface of the rechargeable battery (861) while collector terminals (873, 874) are placed on the inside walls as shown in FIG. 8(e). Diodes (879) are also placed inside the motion cell to form rectifying circuits; the connections of diodes are not shown in FIG. 8(e). Based on similar principles described in previous examples, motion of this battery shaped field effect motion cell (851) can be converted to electrical power charging the rechargeable battery (861).

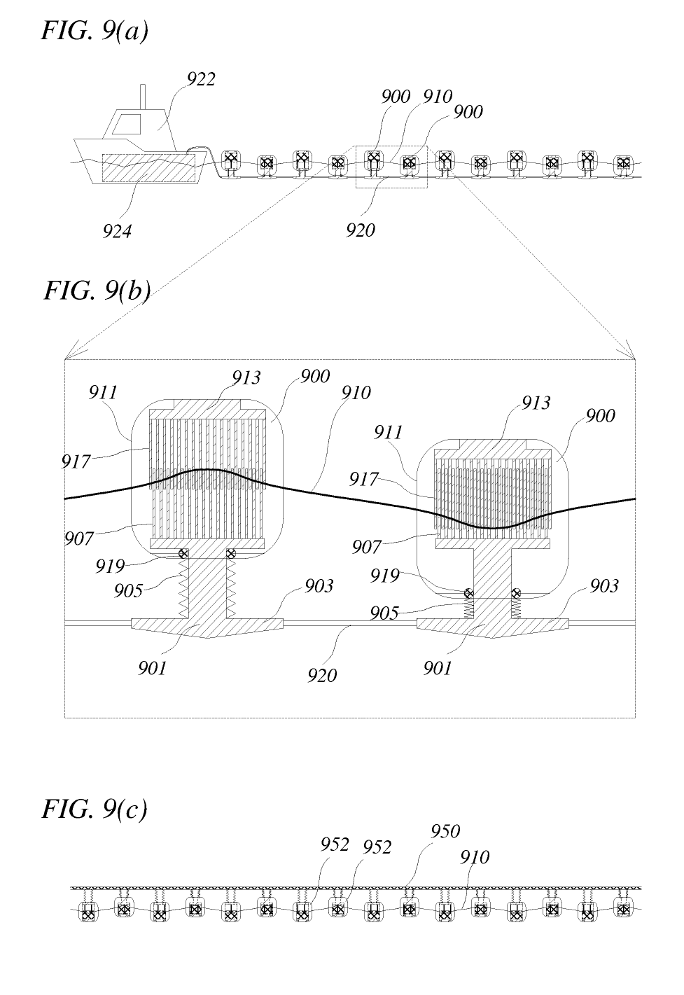

Another major objective of the present invention is to provide environmentally friendly energy collectors. In FIG. 6 we showed motion cells placed inside buoys to convert wave energy into electrical energy. FIGS. 9(a-c) provide additional examples. FIG. 9(a) shows an example that uses many buoys (900) linked by an underwater cable (920). The water waves (910) cause motion of the buoys (900) that convert motion into electrical power to store into a rechargeable battery (924) on a boat (922). We can use any kind of motion cells for this application. FIG. 9(b) is a magnified diagram illustrating an example when field effect motion cells are used for this application. Each buoy (900) comprises a floating container (911), and a fixture (901) linked by springs (905). The floating container (911) moves relatively easily with water waves (910). The fixture (901) is placed under water so that waves (901) affect it less. It also has a side wing (903) that provides counter force against wave motion. The fixtures (901) of different buoys (900) are linked by cables (920) that provide an electrical connection as well as mechanical support for further stability. Therefore the fixtures (901) are relatively stable against wave motion while the floating containers (911) can move with waves relatively easily. We can use the relative motion between the fixtures (901) and the floating containers (911) to generate electrical power using motion cells. For the example shown in FIG. 9(b), the buoy comprises a field effect motion cell (913) that has a plurality of field terminals (917) connected to the floating container (911), and a plurality of collector terminals (907) connected to the fixture (901). The relative motion between the floating container (911) and the fixture (901) cause relative motion between the collector terminals and the field terminals (907, 917) to convert wave energy into electrical power. FIG. 9(c) illustrates an alternative design when a fixture platform (950) is placed above water instead of under water. Since the fixture platform (950) links many buoys (952), the force of water wave (910) is averaged out so that it is relatively more stable than individual buoy. The relative motions between buoys (952) and the fixture platform (950) are therefore convertible into electrical power by motion cells. It is also possible to use the relative motion between different buoys to generate energy. The motion cells, as well as energy storage devices, can be placed inside the buoys or placed on the platform. Using such motion cells, there is no need to build dams to collect energy from water. It is also obvious that similar structures can be placed into vehicles (cars, boats, air planes) to stabilize vehicles while collecting energy at the same time.

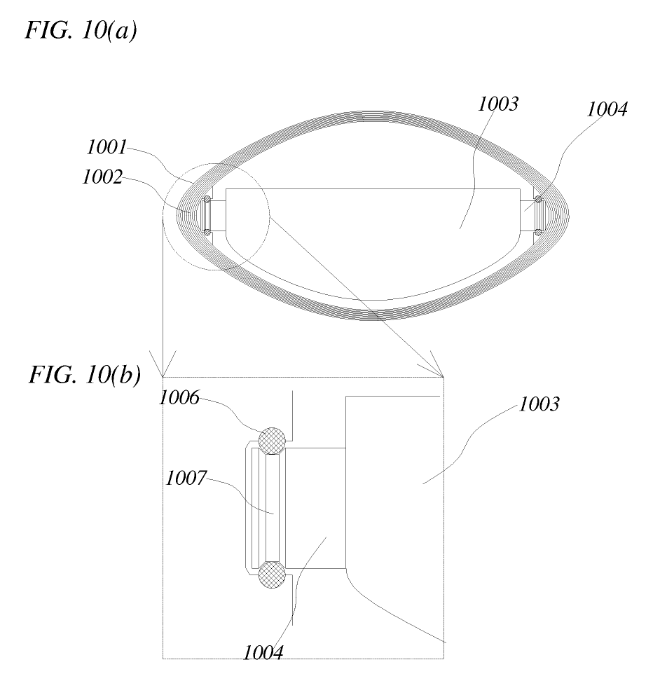

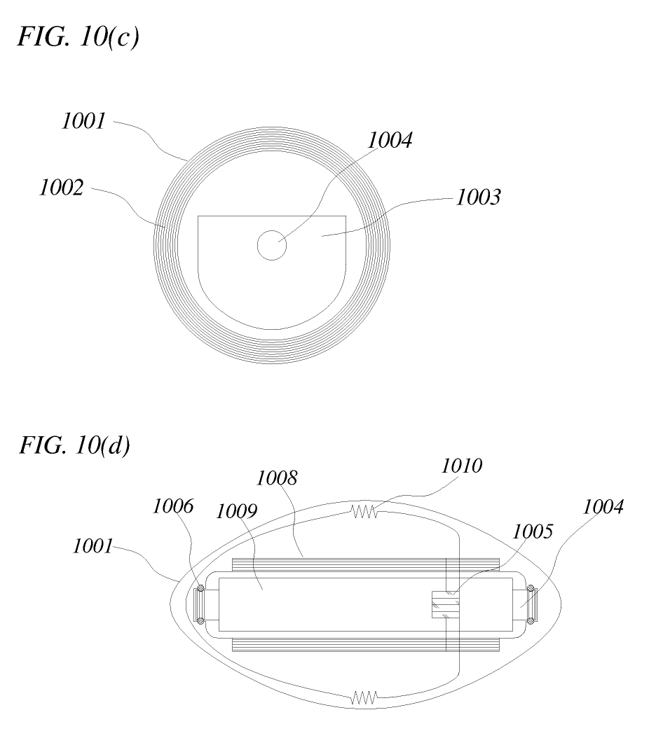

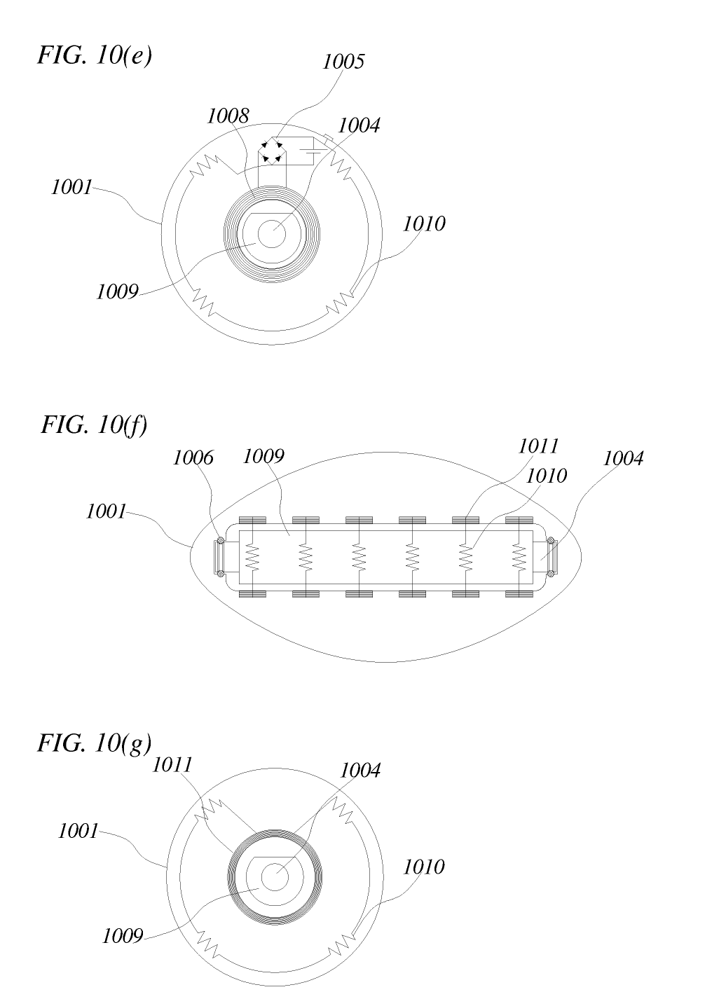

The electrical power generators previously described are useful in storing energy in a wide range of activities. One such example is illustrated by FIGS. 10(a-g). This particular application uses the rotational motion of a football to generate electricity. This power can be used in various ways, such as lighting the ball to allow play in poorly lit areas, or powering speakers on the ball. FIG. 10(a) shows the cross sectional view of the football. The skin (1001) of the ball is like that of conventional footballs. Underneath the skin is the coil (1002). Attached to the coil is a rectifier circuit and rechargeable battery (not shown). Along the lengthwise axis of the ball is an axel (1004) with a magnet (1003) attached to it. The axel (1004) is free to rotate, which is shown more clearly in FIG. 10(b). As shown in the figure, there are small ball bearings (1006) that fit inside a shallow axel groove (1007). When the ball is thrown, the weight of the magnet (1003) will keep the axel (1004) from rotating while the coil (1002) and the skin (1001) rapidly spin around the axel (1004). This motion will generate current in the coil (1002), which goes through the rectifier and charges the battery. FIG. 10(c) shows a cross sectional view from a narrow end of the ball to give a clearer picture of the shape of the magnet (1003).

Normal wear and tear from use of the football may damage the coil (1002) if the ball is built as shown in FIG. 10(a). The magnet also does not need to be so big. FIG. 10(d) depicts a more robust design that uses a smaller magnet (1009) and coil (1008) located closer to the center of the ball where padding between them and the skin (1001) can better protect the device. Again, there is a circuit (1005) that stores the charge generated through the spinning of the ball. This charge is used to power some load (1010), such as a LED. FIG. 10(e) shows this design from the endpoint of the ball to show the shape of the magnet (1009) and one possible rectifier (1005).

In this application, we may not even wish to store charge. We may wish to immediately use the charge generated to light the ball so it only lights up with it is thrown. This design, which is simpler and cheaper, is shown in FIG. 10(f). There is still a bottom heavy magnet (1009) attached to an axel (1004). There are coils (1011) around the magnet that are attached to lights (1010) around the outside of the ball. The figure shows a plurality of coils (1011), but only one may be necessary to light the ball sufficiently. Similarly, the number of lights (1010) is not a fixed number, and these lights (1010) may be connected in parallel or in series. When the ball is thrown, the magnet (1009) and axel (1004) have little rotational motion while the rest of the ball, which includes the coils (1011), rotates around the magnet (1009). This generates current that immediately flows through the lights (1010) to light up the ball regardless of which direction the ball is spinning.

While specific embodiments of the invention have been illustrated and described herein, it is realized that other modifications and changes will occur to those skilled in the art. The scope of the present invention should not be limited by the above specific examples. The figures shown here are not drawn to scale. In reality, a much smaller magnet and coil(s) may be all that is required. These particular figures have a magnet and coil as the electrical power generator, but any of the generators previously described could work in this application. The field effect motion cell described in FIG. 8(d) could be used where the cylindrical field terminal (847) replaces the magnet (1009) and the collector terminals (841, 842) replace the coil (1011). The shape of the ball does not have to be that of a football. The same device could be put inside a baseball, basketball, tennis ball, dart, arrow, etc. As long as the throwing object spins along an axis somewhat parallel to the ground, the device described in FIGS. 10(a-g) can be used to generate electricity. For objects that spin on an axis perpendicular to the ground, a motion cell different than those described so far can be used.

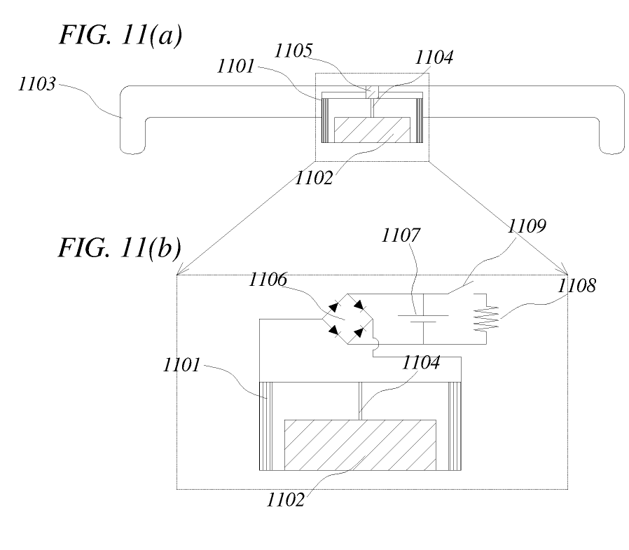

FIG. 11(a) illustrates a hanging motion cell inside a Frisbee (1103). The hanging motion cell comprises a cylindrical coil (1101), and a magnet (1102) hanging by a string (1104) that is securely attached to the Frisbee (1103). The coil (1101) is connected to a circuit and rechargeable battery (1105). FIG. 11(b) is a blown up view of the hanging motion cell. We can see that the storage circuit (1105) comprises a rectifier (1106), a rechargeable battery (1107), some sort of load (1108), and a switch (1109). When the Frisbee (1103) is thrown, the top of the string (1104) will spin as fast as the Frisbee (1103), but the magnet (1102) and the bottom of the string (1104) will not rotate as fast because of inertia. This means the coil (1101) is rotating relative to the magnet (1102), which induces a current that charges the battery (1107). Furthermore, the string (1104) becomes wound up because the top rotates at a different speed than the bottom. Once the Frisbee (1103) stops spinning, the string (1104) will unwind and the magnet (1102) will be rotating relative to the coil (1101). This means both the energy used to begin rotation and the energy used to stop rotation is stored in the battery. This energy can be used to power an LED, speakers, a counter, and various other applications.

While specific embodiments of the invention have been illustrated and described herein, it is realized that other modifications and changes will occur to those skilled in the art. The scope of the present invention should not be limited by the above specific examples. FIGS. 11(a,b) depict the motion attached to a Frisbee, but it is clear that a Frisbee is not the only device that could work. As long as there is an object that spins on an axis perpendicular to the ground, this hanging motion cell could be part of that object to generate electricity. The magnet also does not have to be that part that is attached to the string. The coil could just as easily be attached to the string. The string could also be replaced with a different material such as an elastic band. As long as the top of the string-like material rotates at a different speed than the bottom, the hanging motion cell remains the same invention. The magnet and coil system could also be replaced by the field effect system previously described. We could substitute the magnet with a field terminal and we could substitute the coil with collector terminals. The circuit (1105) shown can also be designed in many different ways, as we have mentioned before.

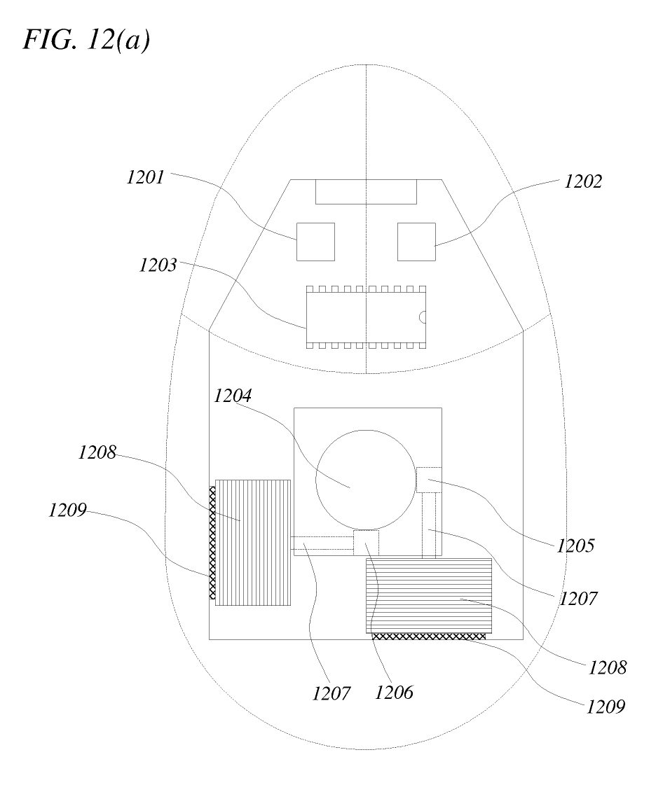

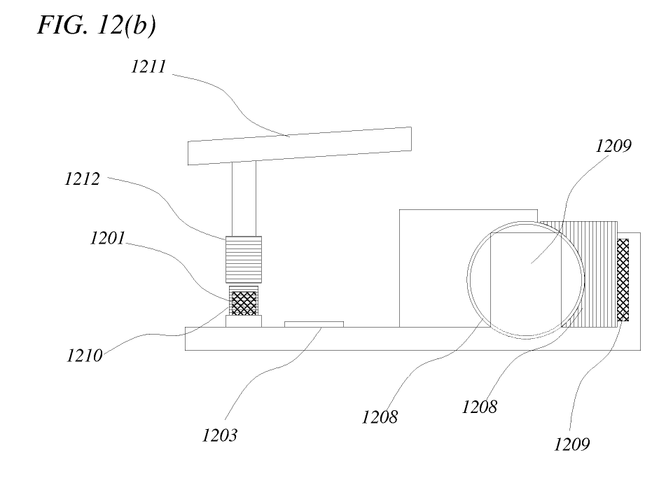

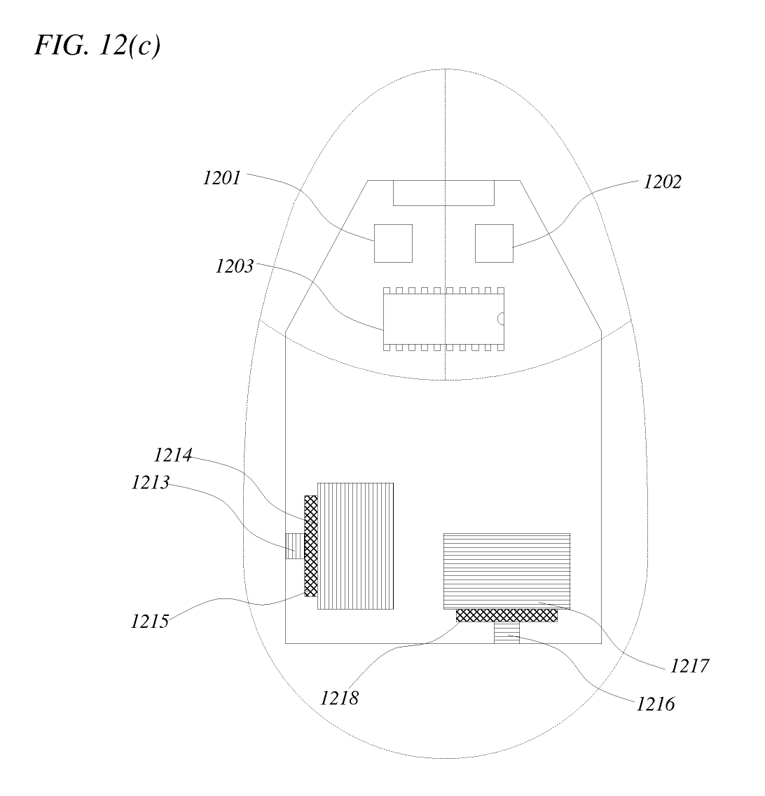

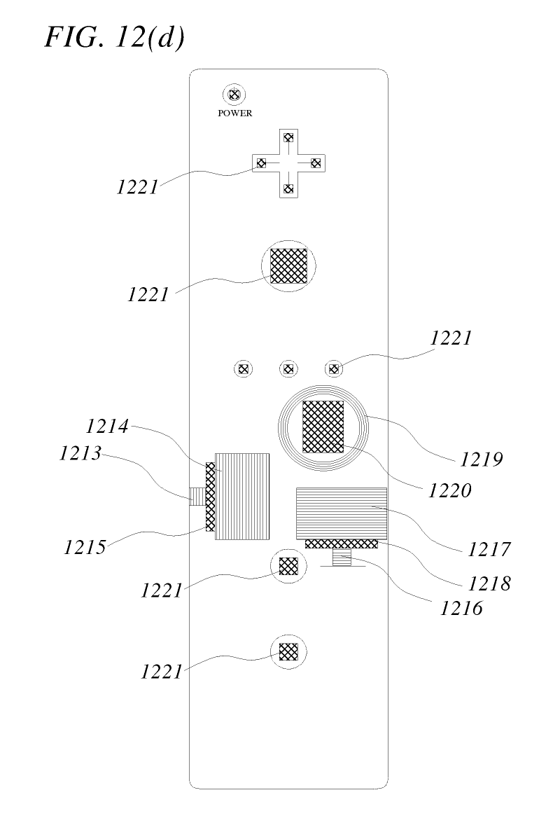

The present invention can do more than just generate electrical power. FIGS. 12(a,b) illustrate a wireless computer mouse that uses electrical power generators to measure speed, and detect button clicks in addition to generating power. FIG. 12(a) depicts the insides of a mouse from a bird's eye view. Like prior art track ball computer mice, there is a tracking ball (1204), an X roller (1205), a Y roller (1206), and a microprocessor (1203). The X roller (1205) and Y roller (1206) are attached to shafts (1207), which are in turn attached to coils (1208). These three parts rotate together. Placed separate from but inside the coils are magnets (1209). In place of the conventional left and right click buttons there is a left click magnet (1201) and right click magnet (1202). When the user moves the mouse left and right, the tracking ball (1204) moves the X roller (1205), which causes its coil (1208) to rotate around its magnet (1209), generating electrical energy. When the user moves the mouse up and down, the tracking ball (1204) moves the Y roller (1206), which causes its coil (1208) to rotate around its magnet (1209), generating electrical energy. This current is used to recharge the mouse battery. Alternatively, since computer mice use very little power, the electrical energy generated by the motion of the track ball may be enough to power the mouse, eliminating the need for a battery. This would let us make batteryless mice, where batteryless is defined as not needing a battery.

Furthermore, there is a linear relationship between the speed at which the coil (1208) rotates and the voltage seen across the coil (1208). This allows us to determine how fast the mouse is moving in the X and Y directions. This enables us to determine position, since we know the starting position. Movement direction is also easily determined by the sign of the voltage seen. If moving the mouse to the right generates a positive voltage, moving it left will generate a negative voltage. Additionally, the voltage across the coil is an analog electrical control signal. This means no information is lost, which allows the mouse to be very sensitive. Voltage is not the only electrical control signal that can be measured. The magnitude and direction of the current induced in the coil can also be used to accurately measure motion. We define the term electrical control signal to mean an electrical signal that influences the output of an electrical device. Voltage, current, and power are all viable electrical control signals that can be used to determine what the mouse outputs.

FIG. 12(b) depicts the mouse from the side to illustrate how button clicks work. When a button (1211) is pushed down, a coil (1212) attached to the button moves down over a magnet (1201). A small spring (1210) then pushes the button (1211) back to its normal position. The motion between the coil (1212) and magnet (1201) generates electrical energy that can be used to help power the mouse. When the button (1211) is pushed down, an electrical control signal is measured in the coil (1212). This can be used to signal the fact that the button (1211) has been pressed. For example, when the button (1211) is pushed down, a voltage will be seen across the coil (1212). When the button (1211) rises up to its original position, a voltage of opposite sign will be seen across the coil (1212). These electrical control signals can be measured to determine when the button was pressed and when it was released.

There are many advantages to a mouse like this. It can extend the battery life of wireless mice. It is also possible to create a batteryless wireless mouse. It can also be very accurate because the electrical control signals are analog; no information is lost. Laser mice take many pictures to measure speed. Track ball mice use a slotted wheel and measure light flashes in order to measure speed. Both of these methods are essentially taking samples of a continuous function. We preserve that continuous function, allowing us to be more accurate.

FIG. 12(c) shows an alternative way of measuring motion without using a tracking ball. Just like the previous mouse, there are button magnets (1201, 1202). There are also two coil, magnet, and spring systems. The X spring (1213), X coil (1214), and X magnet (1215) measure left and right movement; the Y spring (1216), Y coil (1217), and Y magnet (1218) measure up and down movement. Each magnet is attached to a spring and each coil is aligned along the axis whose movement it is measuring. As the user moves the mouse, the magnets will move relative to the coils. This generates electrical energy we can use as part of, or the entirety of, the electrical power supporting the operation of the mouse. Analog electrical control signals can also be measured in the coils. These electrical control signals, along with magnet mass and spring constants, allow us to calculate how fast the mouse is moving in two dimensions.

The computer mice described above measured motion by measuring speed, and therefore position. When we talk of measuring motion, we mean measuring any one of, or any combination of, acceleration, speed, and position. With slight modifications, many other electrical devices can include movable components to measure motion and to power, in part or in entirety, the electrical device. One such example is diagramed in FIG. 12(d). It is a video game controller like the one used with the Nintendo Wii. Like the mouse shown in FIG. 12(c), there are button magnets (1221), an X spring (1213), X coil (1214), X magnet (1215), Y spring (1216), Y coil (1217), and Y magnet (1218). There is also a Z coil (1219), Z magnet (1220), and Z spring (not shown). The Z spring is not shown because it is under the Z magnet. This game controller works exactly like the mouse in FIG. 12(c) except there is just one more dimension that is being measured. As the user moves the controller, the X, Y, and Z magnets extend or compress their respective springs, causing them to move relative to their coils. This generates electrical energy which is used to power the device. This motion also generates electrical control signals in the coils that we can use to measure motion. It is not beyond the scope of the present invention to add any number of additional magnet-coil setups to measure motion along any superposition of the X, Y, and Z axes.

While specific embodiments of the invention have been illustrated and described herein, it is realized that other modifications and changes will occur to those skilled in the art. The scope of the present invention should not be limited by the above specific examples. We have only described the most basic of computer mice. Many mice have more buttons and a mouse wheel. Other buttons can be handled the way the left and right click buttons have been handled here. The mouse wheel can be handled how the X and Y rollers were handled. In all our examples, a magnet and coil do not have to be used to generate power and measure speed. The field effect motion cells previously described can work just as well and probably better because there is no magnetic field that could damage nearby electronics. In FIGS. 12(a,b) we could also use gear trains to multiply the speed at which the coils turn. The coils also do not have to be the part that turns. The magnet could just as easily do the spinning. Similarly, in FIGS. 12(c,d), we could easily swap the magnet with a coil and vice versa. The mice also do not have to be wireless. We can create a wired mouse that is more accurate than conventional mice because our electrical control signals are analog. Shape of the mouse and game controller do not limit the scope of this invention either. We are also not limited to just mice and game controllers. Electrical devices of all shapes and sizes can include movable components to generate electrical power and to measure motion. Other possible applications include pedometers, joysticks, steering wheels, keyboards, calculators, phones, and remote controls. These figures are used to illustrate the fact that electrical power generators of the present invention can be used to measure motion along any number of axes in addition to generating electrical power. Any electronic device that measures speed, acceleration, or position can use the present invention to do so very accurately while generating power at the same time.

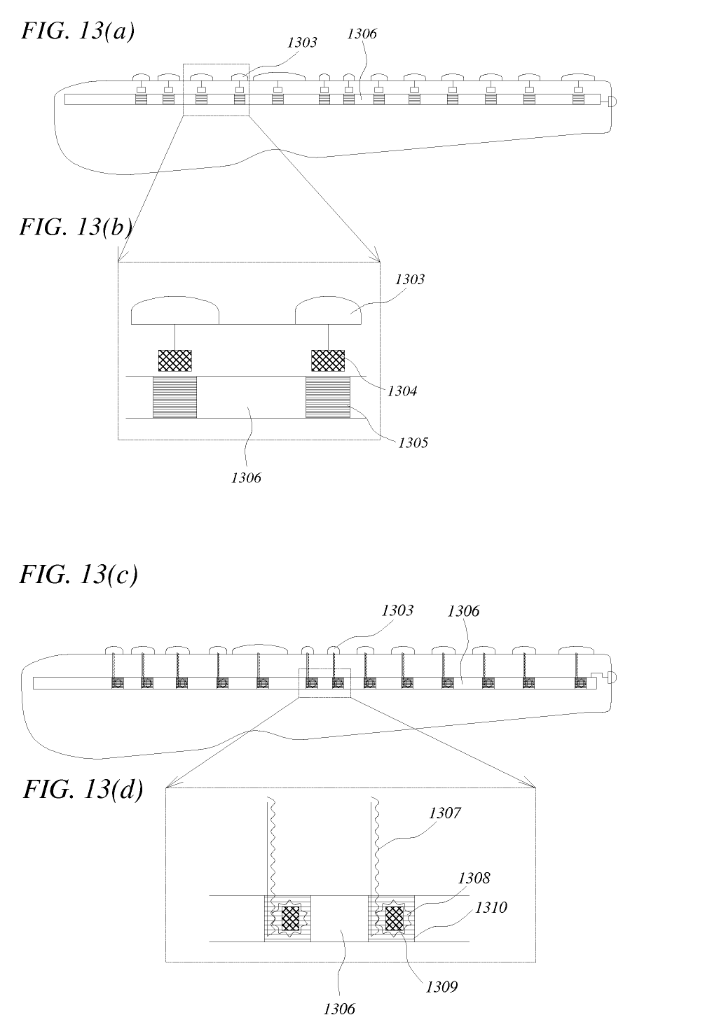

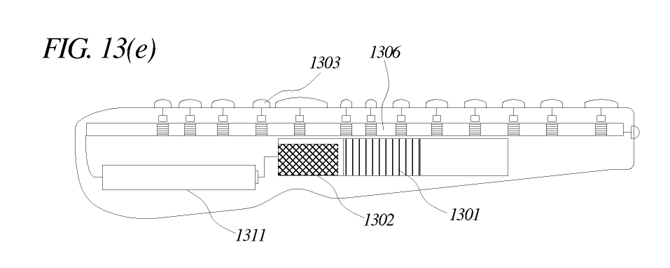

The previous example application introduced the idea that movable components can be used to generate electrical power and to generate electrical control signals essential to the operation of the electrical device. In a track ball mouse, the track ball, X and Y rollers, and buttons are those movable components. In a game controller the buttons, spring, and magnets were the movable components. We now describe a television remote control with its many buttons as its movable components. The television remote control is shown in FIGS. 13(a-e). FIG. 13(a) shows the remote from the side. On top are the buttons (1303). Inside the remote is a circuit board (1306). FIG. 13(b) shows a blown up view of the motion cell button. Attached to each button is a magnet (1304). Built into the circuit board (1306) are coils (1305) through which the magnets (1304) will go once the button (1303) has been pressed. The electrical control signal caused by this motion can be used to determine which button has been pressed and it can also be used to help power the remote.

While specific embodiments of the invention have been illustrated and described herein, it is realized that other modifications and changes will occur to those skilled in the art. The scope of the present invention should not be limited by the above specific examples. This specific type of electrical power generator is not the only type that can be used. FIGS. 13(c,d) depict the same idea using gears to translate linear button motion into rotational motion. The straight gear (1307) seen in FIG. 13(d) turns a circular gear (1308) that has a magnet (1309) attached to it. All of this is located inside a coil (1310). This motion creates an electrical control signal, indicating which button has been pressed and helping to power the remote. Many other variations can be used. For example, the remote shown in FIG. 13(e) includes a rechargeable battery (1311) that is charged by both the motion of buttons and a larger motion cell (1301, 1302). This shows that while it may be possible to power devices solely by button clicks, we could also use those button clicks just to extend battery life. The magnet and coil cells could also easily be replaced by field effect cells. We could also connect all the buttons to one large coil that moves over one large magnet in order to generate more electrical energy. We are also not limited to just television remote controls. Any electronic device with buttons can use the buttons to help recharge the battery.

We have given examples of computer mice, game controllers, and remote controls that use movable components to generate electrical energy that is used to help power the device and used to create electrical control signals that the device uses to determine its output. As we briefly mentioned before, the present invention is not limited by just these examples. We now want to spend some time discussing what sort of devices the present invention deals with. The present invention is really about electrical devices that comprise one or a plurality of movable components. These movable parts can be buttons, wheels, joysticks, springs, weights, charged plates, and many other things. When these movable components move, they generate electrical energy that is used as part of the electrical power supporting the electrical device. The electrical energy generated by these movable components can also be the sole source of power for the electrical device. In addition to providing electrical power, these movable components also produce electrical control signals used in the operation of the electrical device. These electrical control signals can be voltage, current, or power. The electrical device uses these electrical control signals in order to function. We hope that this discussion clearly defines what type of electrical devices the present invention is applicable to.

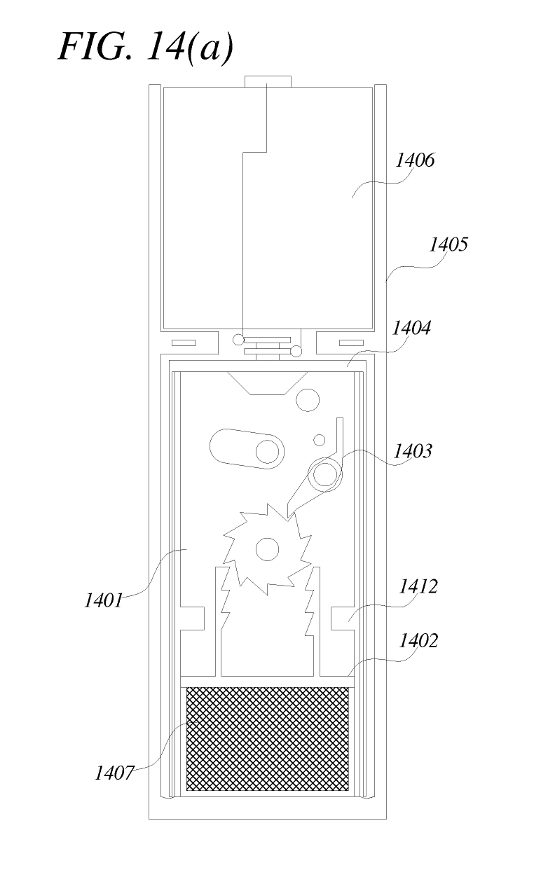

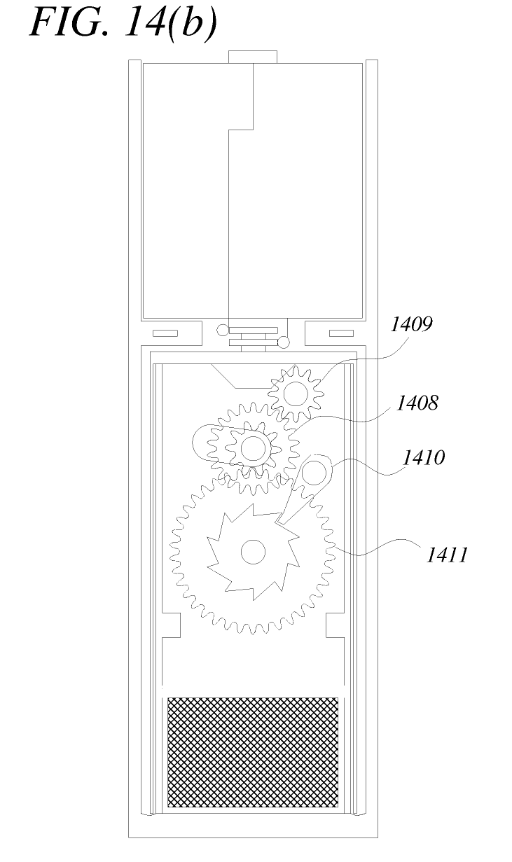

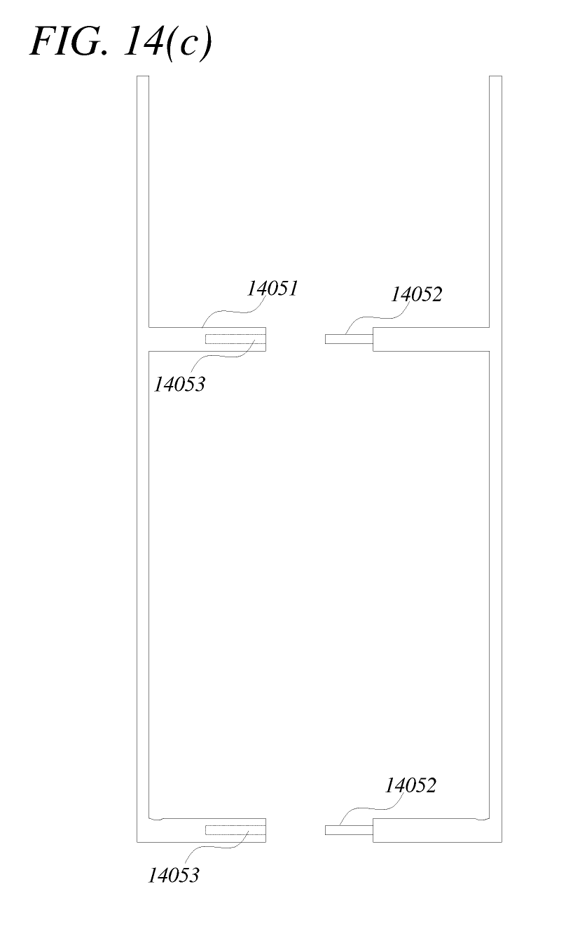

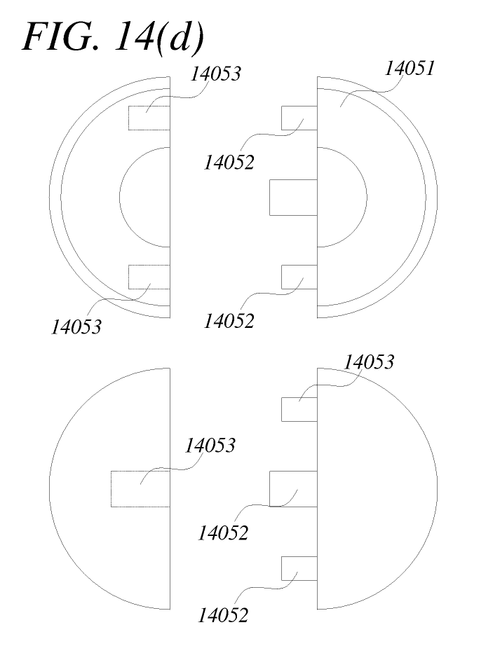

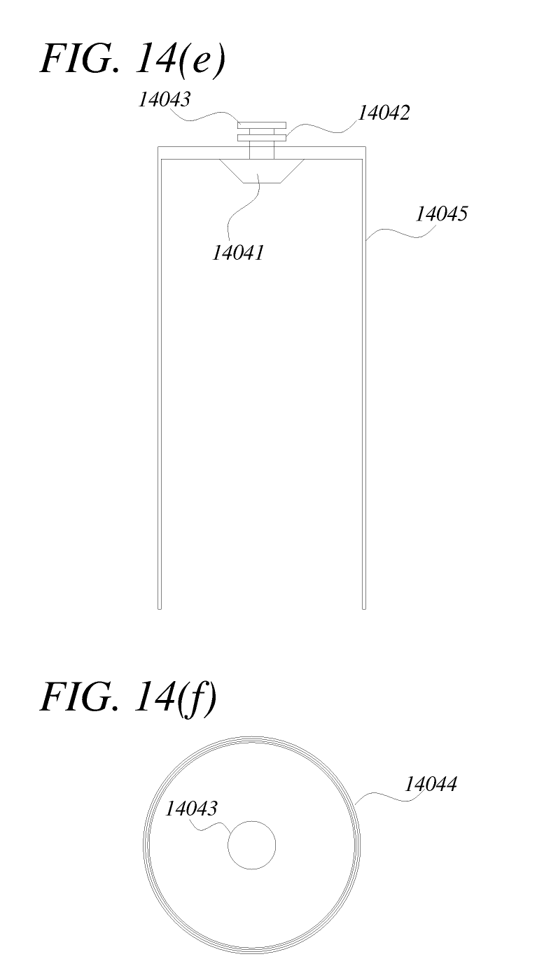

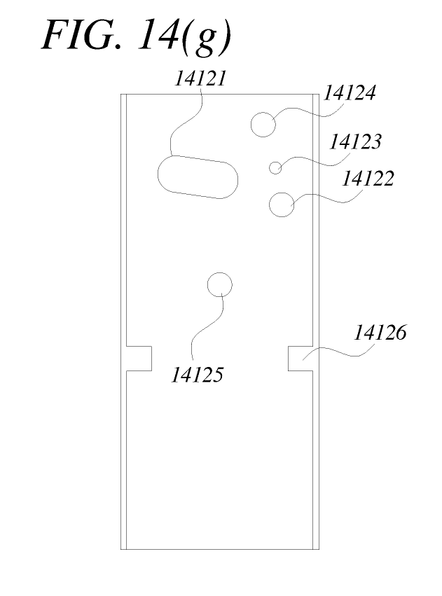

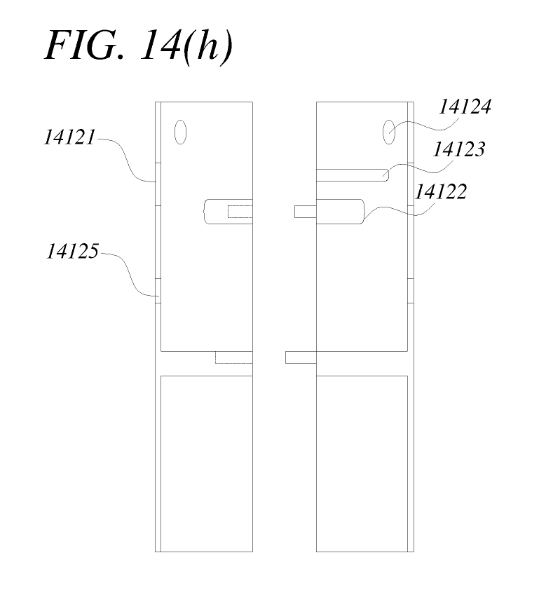

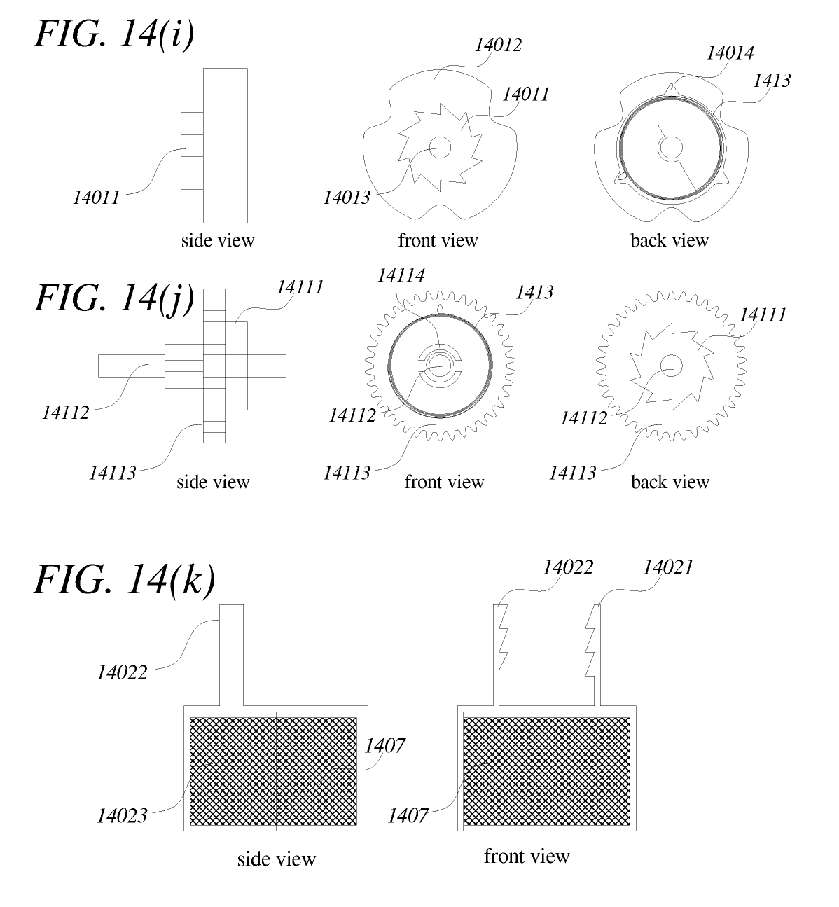

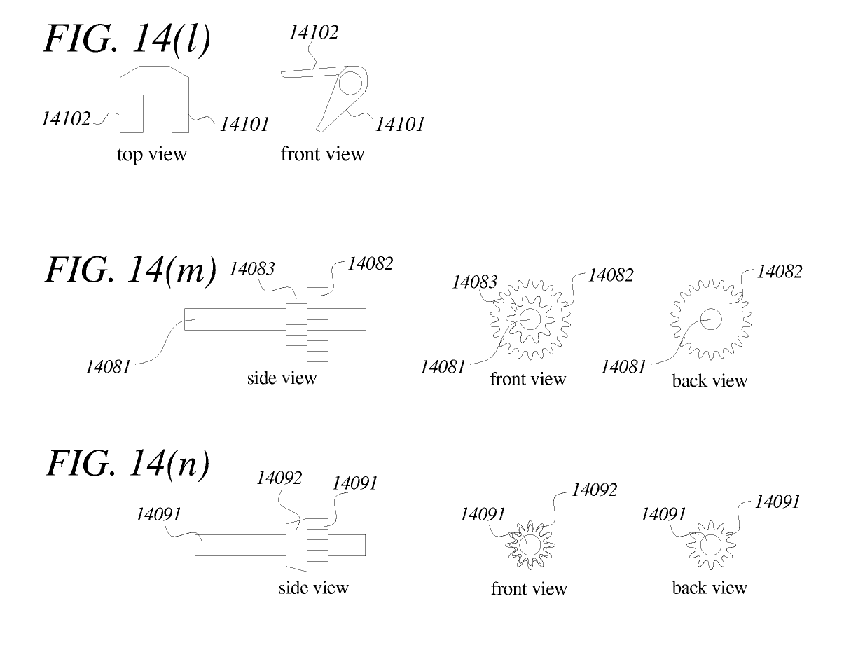

One possible problem with the motion cells described in FIGS. 1-4 is an inability to create a high enough voltage to charge a battery. For example, small movements may only generate 0.5V while 2V may be needed to charge the battery and overcome diode voltage drops. More forceful movements may be required to generate the necessary voltage. In response to this we now describe motion cells that store small increments of energy. When the sum of those increments is great enough, the energy is then released in one large burst which is forceful enough to generate the necessary voltage. FIG. 14(a) illustrates the front of an amplifying motion cell while FIG. 14(b) illustrates the back side of said amplifying motion cell. This example of an amplifying motion cell is the shape of a standard AA battery.

The outside shell (1405) is depicted in FIG. 14(c). Compared to the viewpoint in FIG. 14(a), this viewpoint is rotated 90 degrees around the top to bottom axis. The outer shell (1405) is cylindrical and sized just like the outer shell of a conventional AA battery. It comprises two parts that snap together so the rest of the amplifying motion cell can be easily placed inside. Small protrusions (14052) fit tightly into small recessions (14053), holding the shell together. There is also a circular ridge (14051) where the rechargeable battery (1406) seen in FIGS. 14(a,b) rests on. FIG. 14(d) shows the outer shell (1405) from the top and bottom to better illustrate the circular ridge (14051).

Below the rechargeable battery (1406) is the coil holder (1404). The coil holder is depicted in more detail in FIGS. 14(e,f). FIG. 14(e) gives a side view of the cylindrically shaped coil holder (1404). On the top are the anode connection (14043) and cathode connection (14042). These are discs of conductive material that are connected to the anode and cathode of the rechargeable battery (1406). Right below the top of the coil holder is a bevel gear (14041), which is the piece that makes the coil holder spin. More detail on how this spins will be given later. A coil (14044) wraps around the sides (14045) of the cylinder as shown in the top down view of the coil holder (1404) in FIG. 14(f).

The coil holder rests around the inner shell (1412). The inner shell is shown in more detail by FIGS. 14(g,h). FIG. 14(g) is one half of the inner shell (1412). Like the outer shell (1405), it is cylindrical and snaps together. There are three openings in the side of the inner shell (1412). The releasing slot (14121), the spring casket axel hole (14125), and the bevel gear axel hole (14124). There are also two rods that run across the inner shell (1412). They are the pawl holder (14122) and the pawl stopper (14123). There is also an inner circular ridge (14126). FIG. 14(h) shows the inner shell (1412) rotated 90 degrees to give better perspective on what is a hole, what sticks out, and how the shell snaps together.

The spring casket (1401, 1411) rests along the spring casket axel hole (14125). The spring casket bottom (1401) is shown in FIG. 14(i). The spring casket bottom (1401) comprises a ratchet (14011), a hole running through the center (14013), a hollow cam (14012), and spring holders (14014) carved into the inside of the cam (14012). The spring (1413), which is a clock spring, is shown to illustrate how it fits inside the cam (14012). The spring casket top (1411) is shown in FIG. 14(j). It comprises an axel (14112), a gear (14113), a ratchet (14111), and a spring grabber (14114). The axel (14112) runs through the spring casket bottom hole (14013) and fits into the spring casket axel hole (14125) of the inner shell (1412). The spring (1413) is shown in the figure to illustrate how the spring grabber (14114) secures the spring. The outside of the spring is secured by the spring casket bottom (1401) while the inside of the spring is secured by the spring casket top (1411). The ratchets on both spring casket parts allow them to only rotate in one direction. The bottom spring casket ratchet (14011) also works together with the weight holder (1402) to spin the bottom spring casket (1401).

The weight holder (1402) is shown from two points of view in FIG. 14(k). It comprises a pocket (14023) in which a magnet (1407) rests in, an up pawl (14022), and a down pawl (14021). The magnet (1407) also acts as a weight. Up and down movement of the entire motion cell will cause the weight holder (1402) to also move up and down inside the motion cell. The weight holder's upward movement is stopped by the inner circular ridge (14126). When moving up, the up pawl (14022) pushes the bottom spring casket ratchet (14011) clockwise. When moving down, the down pawl (14021) pushes the bottom spring casket ratchet (14011) clockwise. In this way bidirectional linear motion is translated to unidirectional rotational motion.

As the bottom spring casket (1401) rotates, the spring (1413) inside it becomes coiled. However, the bottom pawl (1403) prevents it from rotating back to its original position. Since the outside of the spring is secured by the bottom spring casket (1401) and the inside of the spring is held by the top spring casket (1411), the top spring casket (1411) will want to follow the rotation that the bottom spring casket (1401) went through. However, this is stopped by the top pawl (1410). The spring is therefore held in a state of tension, which is how the energy is stored. Small up and down movements from the weight holder (1402) coils the spring a little bit more and more until there is a good amount of energy held in the spring. Now there must be some way to release all that energy in one burst. This is accomplished by the top pawl (1410) and the bottom spring casket cam (14012). FIG. 14(l) illustrates the top pawl (1410). There is the actual pawl (14101) and the cam follower (14102). Between these two parts is a gap, which is where the top spring casket gear (14113) fits. The top spring casket ratchet (14111) tries to push the pawl (14101) out of the way, but this is impossible because the cam follower (14102) is pushing against the bottom spring casket cam (14012). However, the cam (14012) has dips in it. When these dips rotate to where the cam follower (14102) is, the top pawl (1410) has room to get pushed out of the way, allowing the top spring casket (14111) to rotate. The top pawl (1410) will no longer prevent the top spring casket (1411) from rotating until the bottom spring casket (1401) has rotated far enough to push the top pawl (1410) back into position. This is how the spring's energy is released. In the diagrams shown, there are three dips in the cam (14012), meaning the spring builds up energy until it is wound ⅓ of a full rotation. We could also have any number of dips to adjust how much energy is built up before being released. The strength of the spring (1413) could also be adjusted to change how much energy is released. This interaction is the heart of the amplifying motion cell, as it is how small amounts of energy are added up before suddenly being released.

When the top spring casket gear (14113) spins, the releasing gear (1408) spins. The releasing gear (1408) is shown in FIG. 14(m). It comprises an axel (14081), a small gear (14083), and a large gear (14082). The axel (14081) rests in the releasing slot (14121). The small gear (14083) is in contact with the top spring casket gear (14113). The large gear (14082) is in contact with the spinner gear (1409), which is shown in greater detail in FIG. 14(n). More specifically, the releasing gear's large gear (14082) spins the spinner gear's gear (14091). The spinner gear's bevel gear (14092) then spins the coil holder's bevel gear (14041). These bevel gears are used to change the axis of rotation. The spinner gear axel (14091) rests in the bevel gear axel hole (14124). This gear train is used to rotate the coil (14044) around the magnet (1407). This induces a current through the coil that recharges the battery (1406). Since the releasing gear's large gear spins just as fast as its small gear, the rotational speed of the spring (1413) is multiplied. This is useful in increasing the voltage generated. Also, when the sudden violent force of the spring (1413) is released, the releasing gear will be pushed upward because of the shape of the releasing slot (14121). That way, when the top spring casket (1411) stops spinning, the rest of the gears will be released from it and keep spinning. Since the top spring casket (1411) can only rotate one full rotation at most—if there is only one dip in the cam (14012)—this releasing action will allow the coil (14044) to rotate much more than would otherwise be possible.

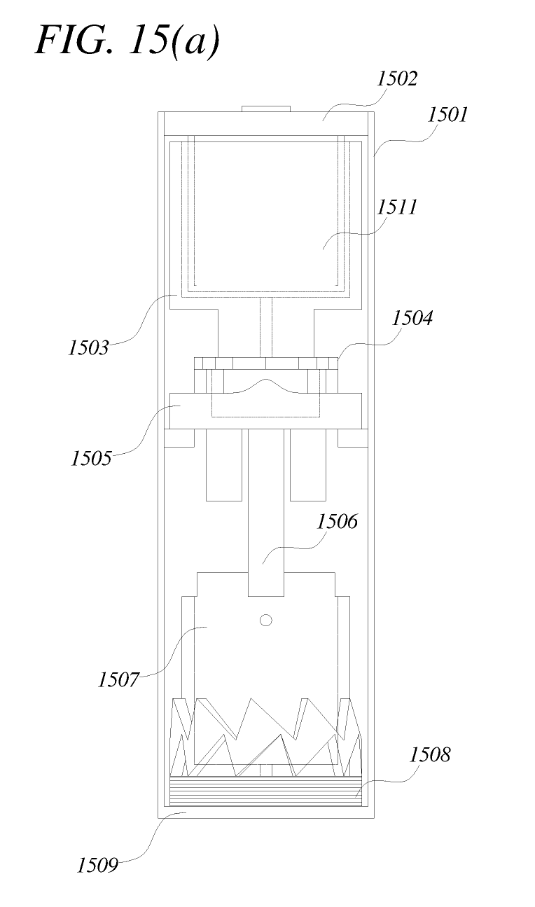

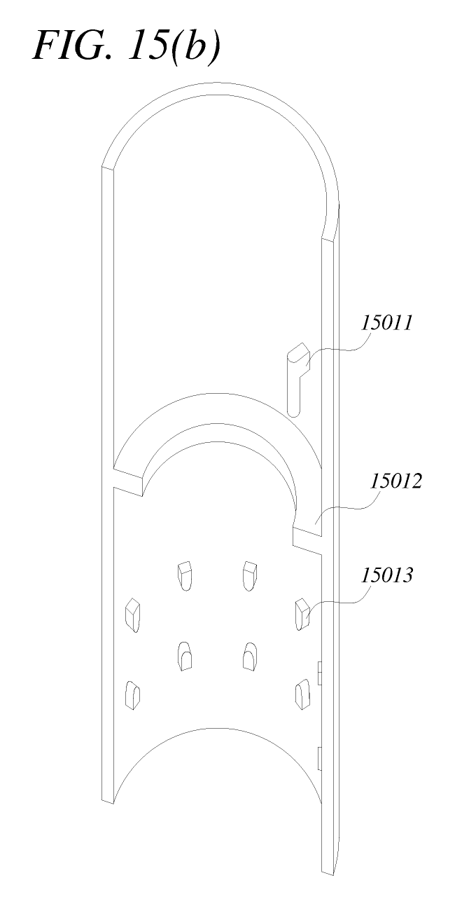

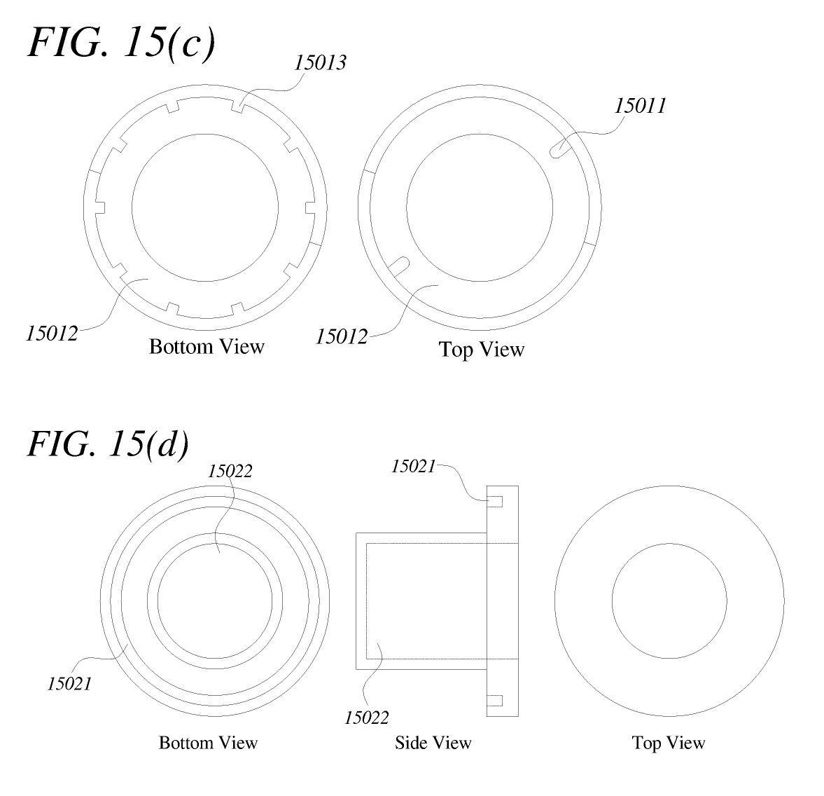

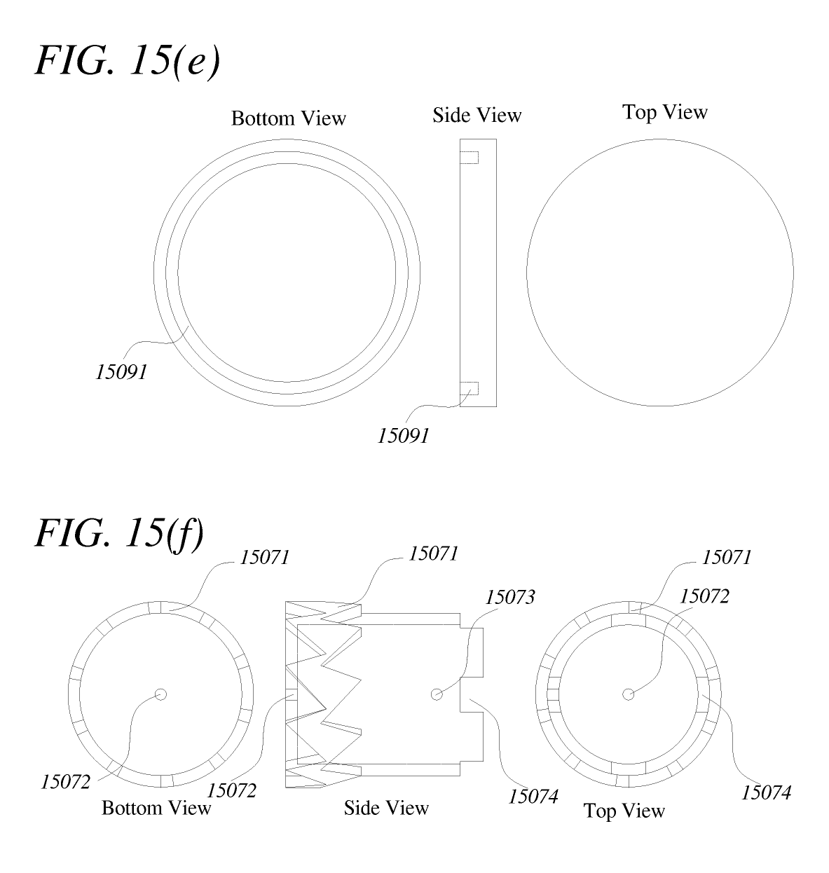

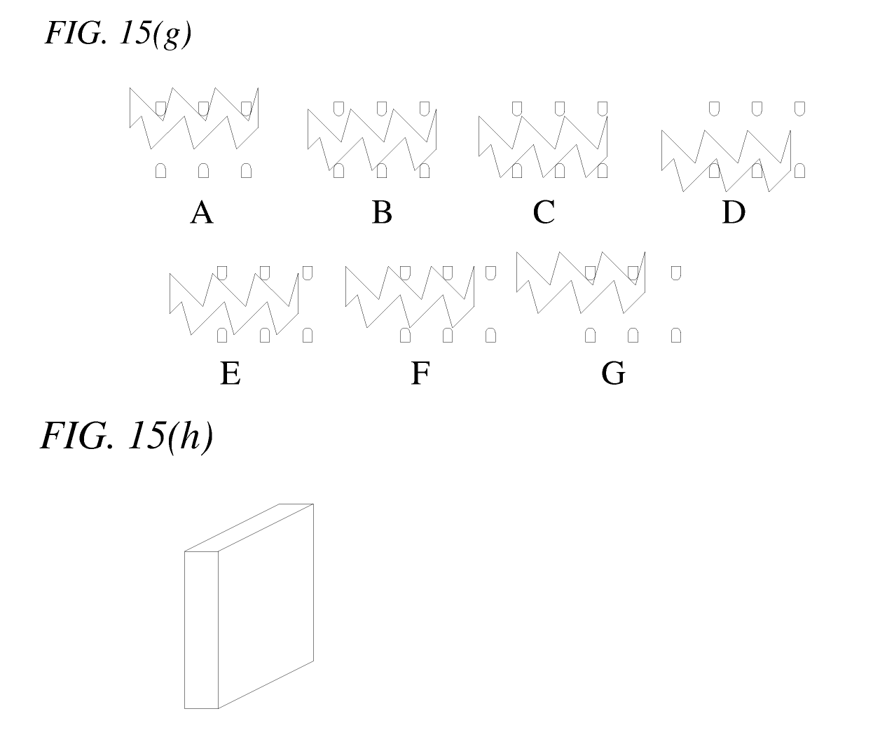

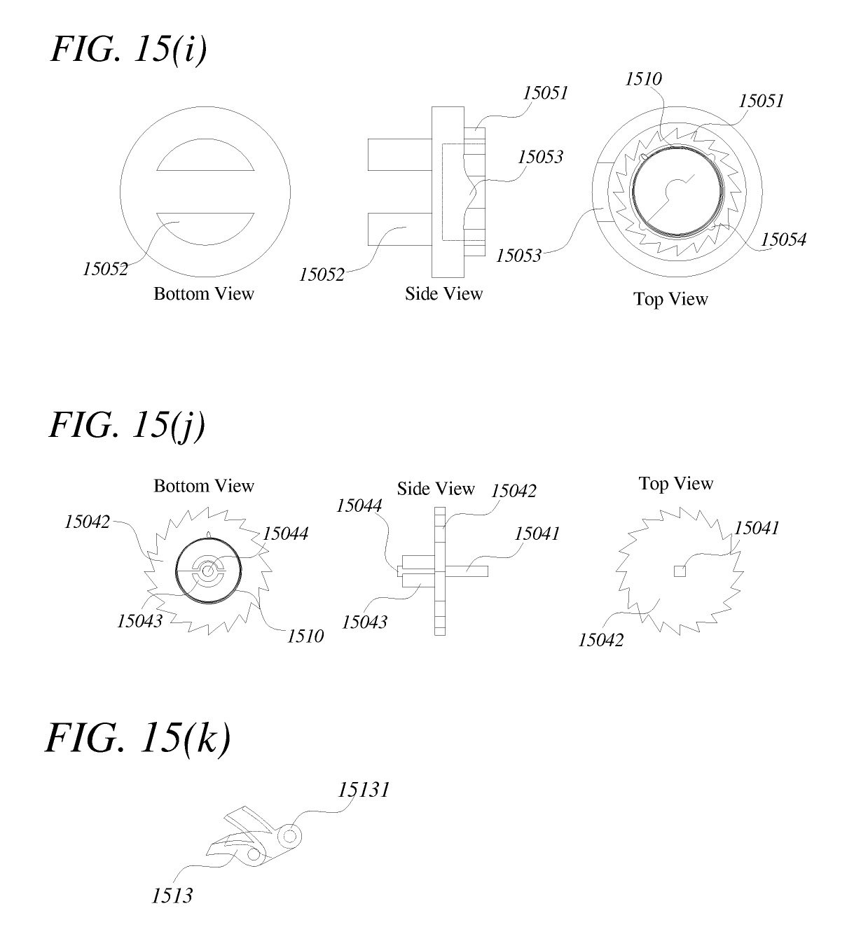

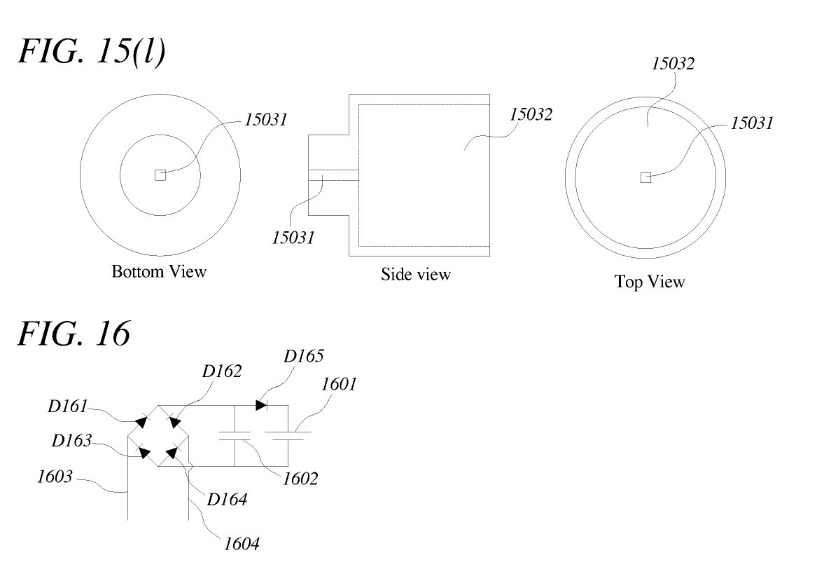

The example above contains many moving parts. We will now describe an example that is simpler. FIG. 15(a) illustrates how all the pieces of the amplifying motion cell come together. There is an outer shell (1501), a top lid (1502), bottom lid (1509), magnet (1511), spinner (1503), spring casket (1505), spring casket lid (1504), connector (1506), rotating weight (1507), and bottom spring (1508). The outer shell (1501) is illustrated in more detail by FIG. 15(b). The outer shell (1501) really is two symmetrical pieces. There is a circular ridge (15012) on which the spring casket (1505) rests. There is also a pawl holder (15011) on which a ratchet pawl (1504) will be placed. There are also bumps (15013) protruding from the outer shell (1501). FIG. 15(c) shows the two outer shell pieces from the top and bottom to give a better perspective of how the entire outer shell (1501) looks. The two pieces of the outer shell (1501) are held together by the top (1502) and bottom (1509) lids. The top lid (1502) is depicted in FIG. 15(d). There is a circular groove (15021) in which the outer shell (1501) pieces snap into. There is also a cylindrical pocket (15022) that holds a magnet (1511). The bottom lid (1509) is even simpler. As seen in FIG. 15(e), it is just a disc that has a circular groove (15091) into which the outer shell (1501) pieces snap.

The outer shell bumps (15013) mentioned before work together with the rotating weight (1507) to translate up and down motion into rotational motion. FIG. 15(f) illustrates the rotating weight (1507). The rotating weight (1507) resembles a hollow cylinder. A rechargeable battery fits inside the cylinder and acts as the weight. There is a bottom hole (15072) and side hole (15073). These holes allow wires to connect to the anode and cathode of the rechargeable battery to the anode and cathode of the entire motion cell. At the bottom of the rotating weight (1507) are triangular protrusions (15071). These protrusions are the source of rotation. FIG. 15(g) illustrates how these triangular protrusions (15071) interact with the outer shell bumps (15013) to rotate the weight. As the rotating weight moves down, the protrusion hits the bottom row of bumps and slides diagonally down. At the end of the downward movement, the bottom spring (1508) pushes the rotating weight (1507) back up. As the weight moves up, the protrusions hit the top row of bumps and slide diagonally upwards. In this way, up and down movements rotate the weight. At the top end of the rotating weight are gaps (15074) in the cylinder. These gaps fit a rectangular connector (1506), which turns the spring casket (1505) much like a screwdriver turns a screw. The connector (1506) is just a rectangular prism, as shown in FIG. 15(h).

The spring casket (1505) is depicted in FIG. 15(i). On the bottom are walls (15052) that fit the connector (1506). This allows the rotating weight (1507) to spin the spring casket (1505). There is also a ratchet (15051), a bump (15053), and spring holders (15054) carved into the casket. A spring (1510) is shown to illustrate how the casket secures the outside of the spring. The spring casket lid (1504) goes on top of the spring casket (1505) and is shown in FIG. 15(j). The lid (1504) comprises spring grabbers (15043), a ratchet (15042), a circular axel (15044), and a square axel (15041). A spring (1510) is shown to illustrate how the spring grabbers (15043) secure the inside of the spring. As the spring casket (1505) is turned by the rotating weight (1507), the spring (1510) becomes wound up. A ratchet pawl (1513) in conjunction with the spring casket ratchet (15051) prevents the spring casket (1505) from returning to its original position. At the same time, another ratchet pawl (1513) and the spring casket lid ratchet (15042) prevents the spring casket lid (1504) from rotating along with the spring casket (1505), keeping the spring (1510) in its wound up position. This is how energy is stored in the spring.

The ratchet pawl (1513) is shown in FIG. 15(k). Besides the pawl (1513) itself, there is a cylindrical extension (15131) that acts like a cam follower. The pawl that keeps the spring casket lid (1504) from rotating is positioned on the pawl holder (15011) with the cylindrical extension (15131) pointed down. As the spring casket (1505) rotates, the bump (15053) rotates as well. When the bump (15053) rotates under the cylindrical extension (15131), the entire pawl rises, letting the spring casket lid (1504) rotate freely. This is when the built up energy in the spring (1510) is released. As the bump rotates more, the pawl (1513) falls back down, locking the spring casket lid (1504) in place. On the other side of the motion cell, an identical pawl (1513) is placed with the cylindrical extension (15131) pointing up. This pawl (1513) prevents the spring casket (1505) from rotating backwards. When this pawl is pushed up, it still keeps the spring casket (1505) from moving because the spring casket ratchet (15051) is thicker than the spring casket lid ratchet (15044).

As the spring casket lid (1504) rotates, so does the spinner (1503). The spinner is shown in FIG. 15(l). It is a hollow cylindrical shape with a square hole (15031) in which the square axel (15041) goes. Around the spinner (1503) goes the coil, and inside the spinner is the magnet (1511). As the coil spins around the magnet (1511), a current is induced and stored inside the rechargeable battery.

While specific embodiments of the invention have been illustrated and described herein, it is realized that other modifications and changes will occur to those skilled in the art. The scope of the present invention should not be limited by the above specific examples. For example, the design shown by FIGS. 15(a-l) could include gears to amplify the speed of rotation. FIGS. 14 and 15 differ in how the outer shell is held together. Minor structural changes like how the shell fits and snaps together should not limit the scope of the present invention. The designs described here also do not have to fit inside only AA batteries as the designs are scalable. A clock spring also does not have to be the method by which energy is stored. Elastic materials could also be used in place of the clock spring to store energy. The magnet and coil method of generating electricity can be replaced by the field effect method previously described. Energy also does not have to be stored mechanically stored. This can be done electrically using a capacitor to build up charge instead of using a spring to build up displacement. One of many such examples is shown in FIG. 16. Opposite ends of a coil contact the two ends of the circuit (1613, 1614). Four diodes (D161-D164) change alternating current to direct current. Small amounts of charge can gather on the capacitor (1602) until there is enough of a voltage across the capacitor (1602) to charge the rechargeable battery (1601). One diode (D165) makes sure the battery does not put charge back onto the capacitor. A circuit like this is one that could be used all over the present invention in place of standard four diode rectifiers. For example, it could be used with the motion cell shown in FIG. 1(a-c) if the voltage generated by the cell in those figures is not great enough to recharge the battery. The capacitor could slowly build up charge until the voltage across it is enough to recharge the battery. The circuit illustrated here to demonstrate just one of the many possible alternative circuits we have been mentioning throughout this document.

The m-cells of the present invention may not be the most efficient ways to collect energy because we emphasize convenience and cost efficiency rather than energy conversion efficiency. Existing clean energy collectors such as solar cells or wind mills are all excellent methods but they can not compete with oil in price. It will take huge investments, including changes in infrastructures in order to reduce reliance on oil for human societies. We believe the present invention provides methods that are low cost and easy to adapt. These low barrier methods can compete with oil in price, and they are very convenient in practical applications. Using motion cells to collect wave energy as illustrated in FIG. 6 and FIGS. 9(a-c) not only can generate electrical power, the motion cells also can absorb wave energy. Therefore, they can make a vehicle carrying motion cell more comfortable. A large number of floating motion cells can calm down wild waves, and serve as shield against dangerous waves. If the area is large enough, such motion cells can reduce the power of natural disasters such as hurricanes or tsunamis. Comparing to other electrical power generators, methods of the present invention can be designed to be environmental friendly. Of course, absorbing energy from natural environment may cause unforeseen effects even when carefully designed with good intentions. The present invention has the advantage of being highly mobile so that we can easily remove or change the structure to make it more environmentally friendly when unforeseen problems are found. It is our hope that motion cells can help human beings burn less oil, build fewer dams, abandon nuclear power plants, and use energy-efficient batteries to make this beautiful planet a better place to live.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. An electrical device comprising one or a plurality of movable component(s) where the motion of said movable component(s) generate(s) electrical energy that is used as part of, or the entirety of, the electrical power supporting the operation of the electrical device and generate(s) an electrical control signal used to support the operation of the electrical device.

2. The electrical device in claim 1 is a computer mouse.

3. The electrical device in claim 2 is a wireless computer mouse.

4. The electrical device in claim 2 is a batteryless computer mouse.

5. The electrical device in claim 2 is a computer mouse that converts motion into analog electrical control signals.

6. The electrical device in claim 1 is a game controller.

7. The electrical device in claim 6 is a game controller with motion detection.

8. The electrical device in claim 6 is a wireless game controller.

9. The electrical device in claim 6 is a batteryless game controller.

10. The electrical device in claim 1 is a remote control.

11. A method for manufacturing an electrical device comprising the steps of providing one or a plurality of component(s) where the motion of said movable component(s) generate(s) electrical energy that is used as part of, or the entirety of, the electrical power supporting the operation of the electrical device and generate(s) an electrical control signal used to support the operation of the electrical device.

12. The method in claim 11 comprises the step of configuration the electrical device as a computer mouse.

13. The method in claim 12 comprises the step of configuration the electrical device as a wireless computer mouse.

14. The method in claim 12 comprises the step of configuration the electrical device as a batteryless computer mouse.

15. The method in claim 12 comprises the step of configuration the electrical device as a computer mouse that converts motion into analog electrical control signals.

16. The method in claim 11 comprises the step of configuration the electrical device as a game controller.

17. The method in claim 16 comprises the step of configuration the electrical device as a game controller with motion detection.

18. The method in claim 16 comprises the step of configuration the electrical device as a wireless game controller.

19. The method in claim 16 comprises the step of configuration the electrical device as a batteryless game controller.

20. The method in claim 11 comprises the step of configuration the electrical device as a remote control.
